(19) United States
(12) Patent Application Publication
(10) Pub. No.: US 2025/0013168 A1
(43) Pub. Date: Jan. 9, 2025

(54) TONER SUPPLY CONTANER AND MOUNTING UNIT

(71) Applicant: CANON KABUSHIKI KAISHA, Tokyo (JP)

(72) Inventors: YUKIO KUBO, Tokyo (JP); HIROYUKI MUNETSUGU, Kanagawa (JP)

(21) Appl. No.: 18/892,778

(22) Filed: Sep. 23, 2024

Related U.S. Application Data
(62) Division of application No. 18/133,040, filed on Apr. 11, 2023, now Pat. No. 12,130,568.
Application No. 18/133,040 is a continuation of application No. PCT/JP2021/039029, filed on Oct. 15, 2021.

(30) Foreign Application Priority Data
Nov. 10, 2020 (JP) 2020-187416

(51) Int. Cl. G03G 15/08; G03G 15/00; G03G 21/16; G03G 21/18

(52) U.S. Cl. CPC G03G 15/0886; G03G 15/0863; G03G 15/0874; G03G 15/80; G03G 21/1619; G03G 21/1647; G03G 21/1652; G03G 21/1867; G03G 21/1871; G03G 21/1875; G03G 21/1878; G03G 21/1885

(57) ABSTRACT

A toner supply container includes a memory portion, a container portion, a discharging portion, and a shutter. The memory portion includes a memory for storing information and an electrode having an exposed surface. The discharging portion is disposed on one end side of the container portion with respect to a first direction. The shutter is configured to rotate around an axis extending in the first direction. As viewed along the first direction, the exposed surface is disposed inside of an imaginary circle that passes through an outer end of the shutter with the axis as a center of the imaginary circle.

### TECHNICAL FIELD

The present invention relates to a toner supply container for use with an image forming apparatus for forming an image on a recording material and a mounting unit for use with the toner supply container.

### BACKGROUND ART

In general, an image forming apparatus of an electrophotographic type forms an image by transferring, onto a transfer material as a transfer medium, a toner image formed on a surface of a photosensitive drum. As an example of such an image forming apparatus, an image forming apparatus of a toner supply type has been known.

In Japanese Laid-Open Patent Application No. H08-30084, a constitution in which a toner supply box for supplying toner is mounted in an image forming apparatus and toner is supplied is described. In International Publication No. 2020/046338, a constitution in which a supply device for supplying toner is provided with a memory device is described.

### SUMMARY OF THE INVENTION

### Problems to be Solved by the Invention

An object of the present invention is to provide a form of a toner supply container.

### Means for Solving the Problem

One of the inventions according to the present application is the following. A toner supply container comprising: a memory portion including a memory for storing information and an electroconductive portion including a first electrode electrically connected to the memory; a container portion for accommodating toner; a discharging portion provided on one end side of the container with respect to a first direction and including a discharge opening which opens toward a direction crossing the first direction and which is for permitting discharge of the toner; and a shutter configured to be rotated around a first axis extending in the first direction and so as to move between a closed position where the shutter covers the discharge opening and a retracted position where the shutter is retracted from the closed position, wherein the first electrode has a first exposed surface exposed to an outside and is provided so that the first exposed surface faces the first direction, and wherein as viewed along the first direction, the first exposed surface is disposed inside an imaginary circle passing through an outer end of the shutter with the first axis as a center.

### Effect of the Invention

According to the present invention, it is possible to provide the form of the toner supply container. Further, it is possible to provide a form of a mounting unit.

### BRIEF DESCRIPTION OF THE DRAWINGS

FIG. 1 is a perspective view of an image forming apparatus.

FIG. 2 is a view for illustrating an inside structure of the image forming apparatus.

FIG. 3 is a side view of the image forming apparatus for illustrating arrangement of a supplying portion.

FIG. 4 is a top (plan) view of the image forming apparatus for illustrating the arrangement of the supplying portion.

FIG. 5 includes enlarged perspective views of the supplying portion.

FIG. 6 includes perspective views of the image forming apparatus.

FIG. 7 includes perspective views of the image forming apparatus.

FIG. 8 includes perspective views of a toner pack according to an embodiment 1.

FIG. 9 includes perspective views of the toner pack according to the embodiment 1.

FIG. 10 includes perspective views for illustrating a shutter unit and a supply base according to the embodiment 1.

FIG. 11 is an illustration of a memory unit according to the embodiment 1.

FIG. 12 includes a perspective views of an end portion (tip portion) of the toner pack according to the embodiment 1.

FIG. 13 includes views for illustrating arrangement of a memory unit according to the embodiment 1.

FIG. 14 includes view for illustrating the arrangement of the memory unit according to the embodiment 1.

FIG. 15 includes views for illustrating a structure of the supplying portion according to the embodiment 1.

FIG. 16 includes views for illustrating the structure of the supplying portion according to the embodiment 1.

FIG. 17 includes views for illustrating mounting of the toner pack according to the embodiment 1.

FIG. 18 includes illustrations of the supplying portion to which the toner pack according to the embodiment 1 is mounted.

FIG. 19 includes illustrations of the supplying portion to which the toner pack according to the embodiment 1 is mounted.

FIG. 20 includes illustrations of an operation of the shutter unit according to the embodiment 1 and a receiving portion shutter.

FIG. 21 includes illustrations of a constitution for restricting movement of the toner pack according to the embodiment 1.

FIG. 22 includes views for illustrating a memory member according to an embodiment 2.

FIG. 23 is an illustration of a container portion according to a modified example.

### EMBODIMENTS FOR CARRYING OUT THE INVENTION

In the following, with reference to the drawings, embodiments for carrying out this invention will be exemplarily described specifically on the basis of the embodiments. However, dimensions, materials, shapes of constituent components described in the embodiments, and relative arrangements of these constituent parts should be appropriately changed depending on constitutions of devices (apparatuses) to which the invention is applied and on various conditions. That is, the scope of this invention is not intended to be limited to the following embodiments. Further, in the drawings used for the following description, for explanation, the components or a part of the components are shown in an omitted manner or in a simplified manner.

### Embodiment 1

### [General Constitution of Image Forming Apparatus]

A general constitution of an image forming apparatus 1 in this embodiment will be described. The image forming apparatus 1 of this embodiment is a monochromatic laser beam printer using an electrophotographic process and forms an image on a recording material P with developer (toner) depending on image information sent from an external device such as a personal computer. Recording paper, label paper, an OHP sheet, a cloth, and the like are examples of recording material P.

Further, in the following description, a height direction (direction opposite to the direction of gravitation) of the image forming apparatus 1 in the case where the image forming apparatus 1 is installed on a horizontal surface is referred to as Z direction. A direction which crosses the Z direction and which is parallel to a rotational axis direction (main scan direction) of a photosensitive drum 411 described later is referred to as X direction. A direction crossing the X direction and the Z direction is referred to as Y direction. The X direction, the Y direction, and the Z direction may preferably cross perpendicularly each other. For convenience, in the X direction, a plus side is called a right(-hand) side and a minus side is called a left(-hand) side, and in the Y direction, a plus side is called a front side or a front surface side and a minus side is called a rear side or a rear surface side, and in the Z direction, a plus side is called an upper side and a minus side is called a lower side. In this embodiment, the Z direction is parallel to a vertical direction, and the X direction and the Y direction are parallel to a horizontal direction.

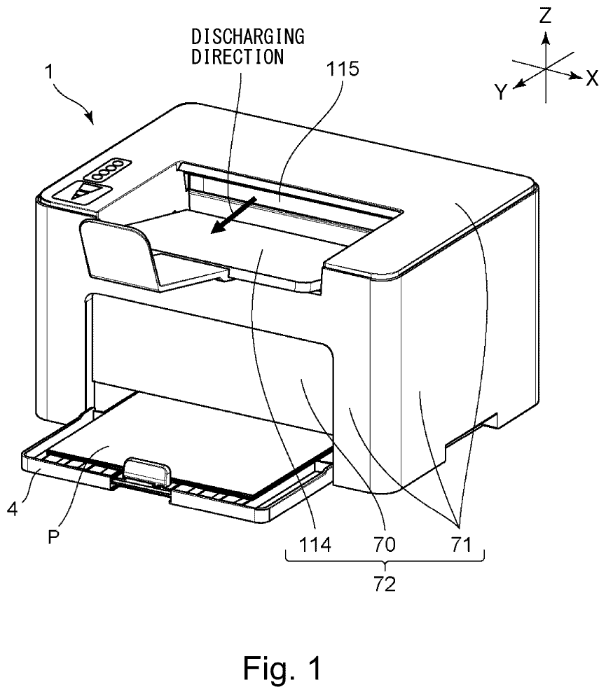

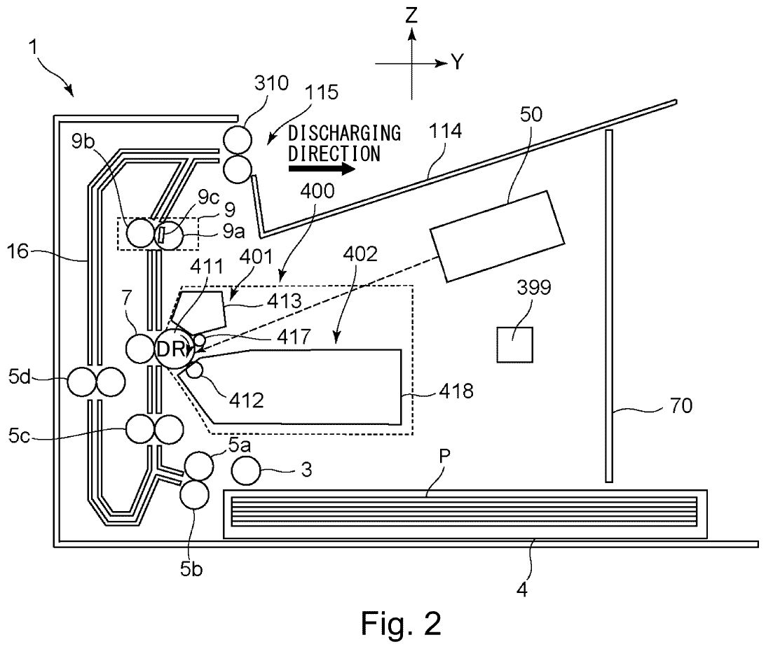

FIG. 1 shows a perspective view of the image forming apparatus 1, and FIG. 2 is a view for illustrating an internal structure of the image forming apparatus 1 as viewed from the X direction (rotational axis direction of the photosensitive drum 411). FIG. 2 principally shows members relating to an image forming process. In FIG. 1, the image forming apparatus 1 includes a feeding tray 4 in which recording materials P are accommodated and a discharging tray 114 on which discharged recording materials P are stacked. The feeding tray 4 is capable of being pulled out in the Y direction, and a user is capable of supplying (replenishing) the recording materials P to the feeding tray 4. The recording materials P which are fed from the feeding tray 4 and on which images are formed are discharged from a discharge opening 115 toward a discharging direction (Y direction) indicated in FIG. 1, and are stacked on the discharging tray 114.

A front cover 70 is provided at a part of an end surface (part of a front surface) of the image forming apparatus 1 on a downstream side of the discharging direction. A side surface or a top surface of the image forming apparatus 1 which is a part of the front surface other than a place where the front cover 70 is provided with an outer casing cover 71. The front cover 70, the outer casing cover 71, and the above-described discharging tray 114 form together a casing 72 of the image forming apparatus 1. Here, the casing 72 is a member covering entirety of the image forming apparatus 1 and includes a process member such as a scanner unit 50 (described later) inside thereof. The above-described discharge opening 115 is an opening formed at a part of the casing, and the recording material P passes through this opening and is discharged to outside of the image forming apparatus 1.

The image forming apparatus 1 includes an image forming portion 400 including a photosensitive unit 401 provided with the photosensitive drum 411 and a charging roller (charging member) 417 and a developing unit 402 provided with a developing roller 412 and an accommodating portion 418. The photosensitive drum 411 is an image bearing member for bearing an electrostatic latent image. The developing roller 412 is a developer carrying member for carrying toner as developer.

Using FIG. 2, a flow of the image forming operation for the recording material P will be described. When image information is sent to the image forming apparatus 1, on the basis of a print start signal, the photosensitive drum 1 which is a rotatable member is rotationally driven in an arrow DR direction at a predetermined peripheral speed (process speed). The scanner unit 50 irradiates the photosensitive drum 411 with laser light on the basis of inputted image information. The scanner unit 50 includes a laser oscillator, a polygon mirror and lenses for irradiating the photosensitive drum 411 with the laser light, a scanner motor for rotating the polygon mirror, and a frame for supporting these members. The photosensitive drum 411 is electrically charged in advance by the charging roller 417, and the electrostatic latent image is formed on the photosensitive drum 411 by irradiating the photosensitive drum 411 with the laser light. Thereafter, the toner accommodated in the accommodating portion 418 is carried to the photosensitive drum 411 by the developing roller 412, whereby this electrostatic latent image is developed and a toner image is formed on the photosensitive drum 411.

In parallel to the above-described image forming process, the recording material P is fed from the feeding tray 4. On a feeding passage of the image forming apparatus 1, a pick-up roller 3, a feeding roller 5a, and a conveying roller pair 5c are provided. The pick-up roller 3 contacts an uppermost one of the recording materials P accommodated in the feeding tray 4 and feeds the recording material P by rotation of the roller itself. The feeding roller 5a and a separation roller 5b press-contacted thereto form a separation nip. In the case where a plurality of sheets of the recording materials P are fed to the separation nip by the influence of a frictional force between the recording materials P, the feeding roller 5a and the separation roller 5b separates the plurality of recording materials P and feed only the recording material P positioned in an uppermost position toward a downstream side.

The recording material P fed from the feeding tray 4 is conveyed toward a transfer roller 7 by the conveying roller pair 5c. To the transfer roller 7, a transfer bias is applied, so that the toner image formed on the photosensitive drum 411 is transferred onto the recording material P. The recording material P on which the toner image is transferred by the transfer roller 7 is subjected to a heating and pressing processing by a fixing device 9, so that the toner image is fixed on the recording material P. The fixing device 9 is constituted by a heating roller 9a in which a fixing heater 9c is incorporated and a pressing roller 9b urged toward the heating roller 9a. Further, the recording material P on which the toner image is fixed is discharged onto the discharging tray 114 by a discharging roller pair 310.

In the case where images are formed on both sides of the recording material P, the discharging roller pair 310 subjects the recording material P on which first side the image is formed to switch-back, and thus guides the recording material P to a double-side feeding passage 16. The recording material P guided to the double-side feeding passage 16 is conveyed again toward the transfer 7 by a double-side conveying roller pair 5d. The recording material P is, after the image is formed on a second side, discharged onto the discharging tray 114 by the discharging roller pair 310.

Further, the toner remaining on the photosensitive drum 411 after the toner image is transferred onto the recording material P is removed by a cleaning unit 413.

The image forming apparatus is provided with a CPU 399 as a controller.

### [Arrangement and Constitution of Supplying Portion]

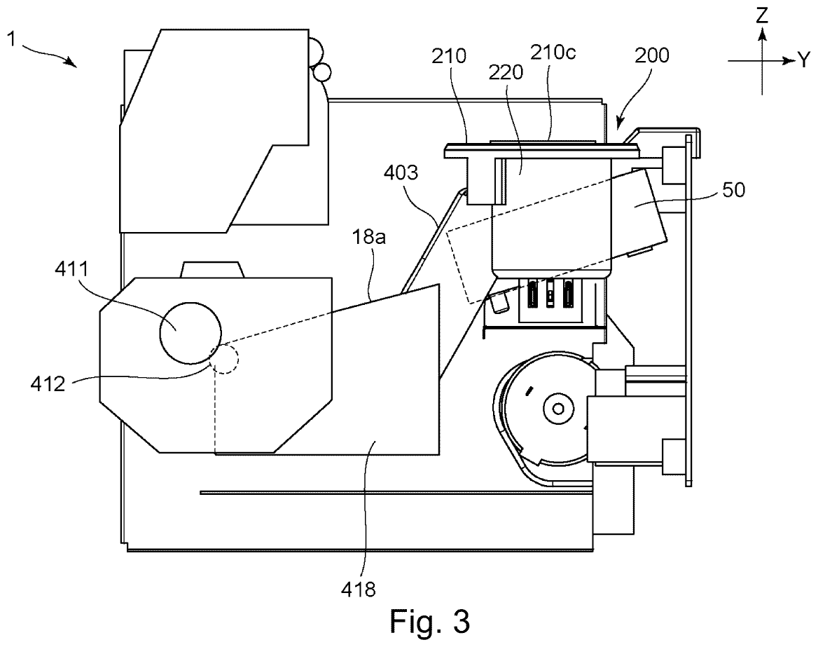

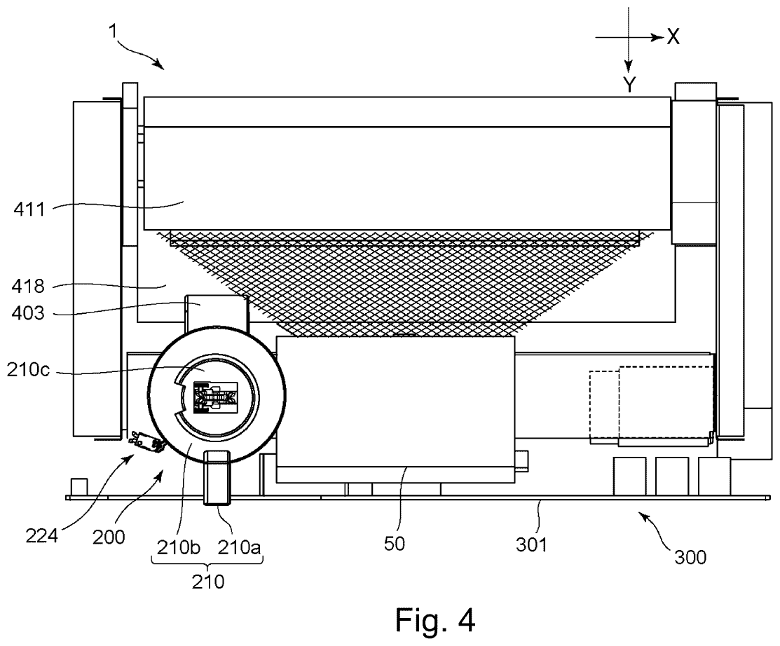

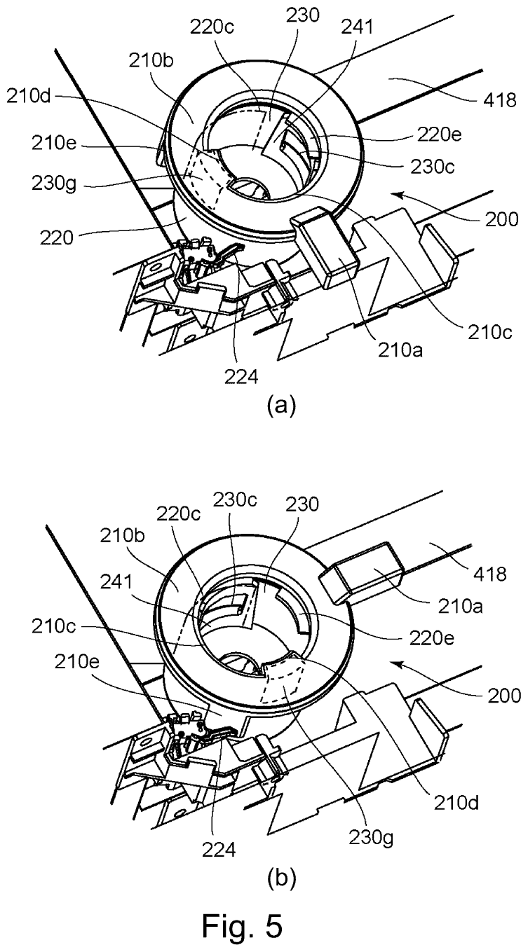

Next, using FIG. 3, FIG. 4, part (a) of FIG. 5, and part (b) of FIG. 5, a supplying portion 200 will be described.

The image forming apparatus 1 is provided with the supplying portion 200 to which a user or a service person is capable of supplying the toner from outside without demounting the accommodating portion 418 from the casing in the case where a remaining toner amount in the accommodating portion 418 becomes small. A constitution in which a toner pack 10 (described later) is detachably mountable to the supplying portion 200 is employed. The image forming apparatus 1 in this embodiment is capable of supplying the toner to the accommodating portion 418 through the supplying portion 200 without removing the image forming portion 400 from the casing 72.

FIG. 3 is a side view of the image forming apparatus 1 for illustrating arrangement of the supplying portion 200. FIG. 3 is a left-hand side view of the image forming apparatus 1 when viewed along a rotational axis direction of the photosensitive drum 411. In FIG. 3, a part of the outer casing cover 71 is omitted, so that an inside of the image forming apparatus 1 is shown. The supplying portion 200 is provided with a mounting portion 210 on which the toner pack 10 (not shown in FIG. 3) is mounted, a toner receiving portion 220, a supply path portion 403 connecting the accommodating portion 418 and the toner receiving portion 220.

The mounting portion 210 is disposed on a top surface portion 340 described later and in which a mounting hole 210c in which the toner pack 10 is mounted is formed. The toner is moved from the toner pack 10 mounted in the mounting hole 210c to the toner receiving portion 220 and the supply path portion 403 in that order, and is finally supplied to the accommodating portion 418.

FIG. 4 is a side view of the image forming apparatus 1 for illustrating the arrangement of the supplying portion 200. FIG. 4 is a top (plan) view of the image forming apparatus 1 from which the outer casing cover 71 is removed. As described above, in the mounting portion 210, the mounting hole 210c is formed. Further, the mounting portion 210 is provided with a ring portion 210b disposed so as to surround the mounting hole 210c and a gripping portion 210a connected to the ring portion 210b. As shown in FIG. 4, a width of the supplying portion 200 with respect to the X direction is shorter (narrower) than a width of the accommodating portion 418 with respect to the X direction. The supplying portion 200 is disposed while avoiding a laser irradiation region (lattice-like hatched portion in FIG. 4) of the laser light emitted from the scanner unit 50.

FIG. 5 includes enlarged perspective views of the supplying portion 200. Part (a) of FIG. 5 is a view showing a state in which the gripping portion 210a is positioned in an initial position, and part (b) of FIG. 5 is a view showing a state in which the gripping portion 210a is positioned in a supplying position.

On cylindrical-shaped inner wall of the toner receiving portion 220, a receiving opening 220c connected to the supply path portion 403 is formed. The toner passes from the toner receiving portion 220 through this receiving opening 200c and is guided to the supply path portion 403, and thereafter, passes through the supply path portion 403 and is accommodated in the accommodating portion 418.

In part (a) of FIG. 5, the receiving opening 220c formed in the toner receiving portion 220 is closed by a receiving portion shutter 230, and is not actually seen, and therefore, is indicated by a dotted line. The receiving portion shutter 230 is a cylindrical-shaped member concentric with the toner receiving portion 220 and is provided inside the toner receiving portion 220. In the receiving portion shutter 230, a shutter opening 230c for permitting passing of the toner is formed, but is not actually seen, and therefore, is indicated by a dotted line. At a periphery of the shutter opening 230c, a receiving seal 241 is disposed. In part (a) of FIG. 5, the receiving opening 220c and the shutter opening 230c are in deviated positions, and therefore, the receiving opening 220c is blocked.

In this embodiment, a constitution in which even in the case where the mounting portion 210 is rotated in a state in which the toner pack 10 is not mounted, the receiving portion shutter 230 is prevented from rotating is employed. On the other hand, when the toner pack 10 is mounted, an engaging projection 210d of the mounting portion 210 and a transmitting portion 230g of the receiving portion shutter 230 engage with a shutter member 11 for the toner pack 10 described later. By that, the user grips of the gripping portion 210a and rotates the gripping portion 210a by about 90° from a state of part (a) of FIG. 5 to a state of the part (b) of FIG. 5, so that the receiving portion shutter 230 can be rotated inside the toner receiving portion 220.

In part (b) of FIG. 5, the receiving opening 220c and the shutter opening 230c are in overlapping positions, and therefore, the receiving opening 220c is opened and is in a state in which the toner can be supplied through the receiving opening 220c.

When the image is formed on the recording material P, the toner is stirred in the accommodating portion 418 by an unshown stirring member, so that there is a need to block the receiving opening 220c so that the toner does not leak out through the receiving opening 220c. Accordingly, during image formation, the gripping portion 210a is moved to the position shown in part (a) of FIG. 5. This position is called an initial position of the gripping portion 210a. On the other hand, when the toner is supplied from the toner pack 10 to the accommodating portion 418, there is a need to open the receiving opening 220c. Accordingly, during toner supply, the gripping portion 210a is moved to the position shown in part (b) of FIG. 5. This position is called a supplying position of the gripping portion 210a.

The image forming apparatus 1 is provided with a lever position detecting sensor 224. The mounting portion 210 is provided with a portion-to-be-detected 210e contacting the lever position sensor 224. When the gripping portion 210a is in the supplying position, the portion-to-be-detected contacts the lever position sensor 224. As a result thereof, it is possible to detect that the lever 210a is in the supplying position. When the gripping portion 210a is in the initial position, the portion-to-be-detected 210e is separated from the lever position sensor 224.

The toner receiving portion 220 is provided with a base supporting portion 220e engaging with a circumferential groove portion 11g of a shutter member 11 described later. The base supporting portion 220e engages with the circumferential groove portion 11g during a process in which the gripping portion 210a is moved from the initial position to the supplying position, and thus restricts removal of the toner pack 10.

### [Mounting Procedure of Supply Container]

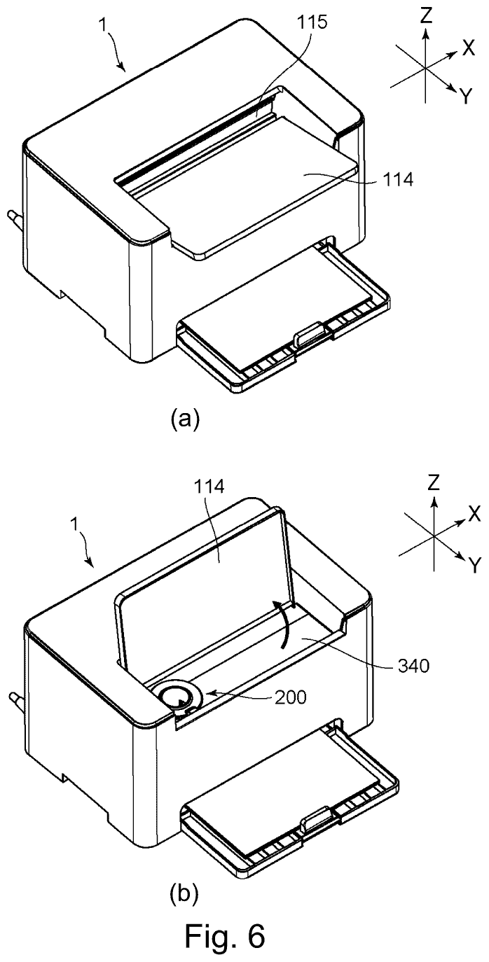

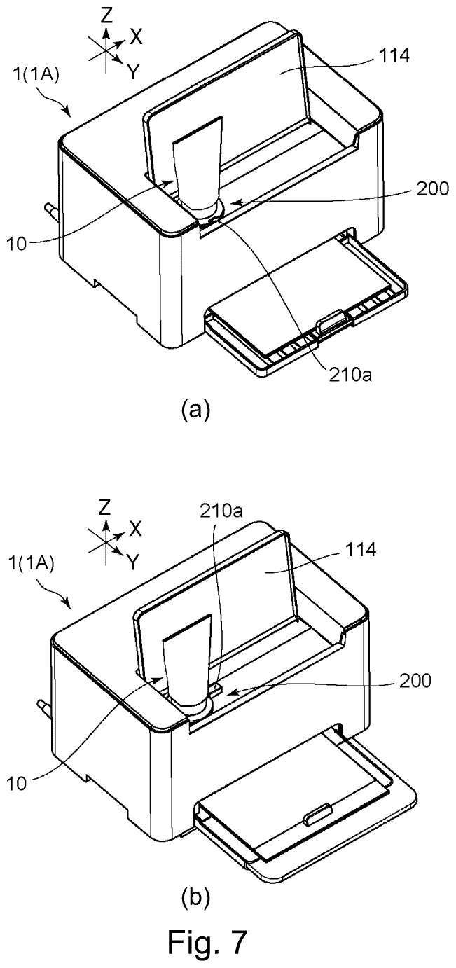

Next, using part (a) of FIG. 6, part (b) of FIG. 6, part (a) of FIG. 7, and part (b) of FIG. 7, a toner supplying procedure with use of the toner pack 10 will be described.

FIG. 6 shows perspective views of the image forming apparatus 1. Part (a) of FIG. 6 is the perspective view of the image forming apparatus 1 in a state in which the discharging tray 114 is closed. Part (b) of FIG. 6 is the perspective view of the image forming apparatus 1 in a state in which the discharging tray 114 is open.

FIG. 7 shows perspective views of the image forming apparatus 1. Part (a) of FIG. 7 is the perspective view of the image forming apparatus 1 in which the gripping portion 210a is in the initial position. Part (b) of FIG. 7 is the perspective view of the image forming apparatus 1 in which the toner pack 10 is mounted and the gripping portion 210a is in the supplying position.

The supplying portion 200 is provided at the top surface portion 340 of an upper portion of the front surface of a main assembly of the image forming apparatus 1. The discharging tray 114 is configured to be movable between a position where the supplying portion 200 is covered and a position where the supplying portion 220 is exposed.

Specifically, in this embodiment, the discharging tray 114 has a constitution in which the discharging tray 114 covers the supplying portion 200 and is movable between a position where the recording materials P discharged from the discharge opening 115 are capable of being stacked (part (a) of FIG. 6) and a position where the supplying portion 200 is exposed (part (b) of FIG. 6). The supplying portion 200 is provided at the upper portion of the front surface of the main assembly of the image forming apparatus 1, and therefore, the user can easily to access the supplying portion 200 also during the supply.

When the toner is to be supplied, the recording materials P stacked on the discharging tray 114 are removed, and the discharging tray 114 is opened and is moved to the position shown in part (b) of FIG. 6. When the discharging tray 114 is opened, the supplying portion 200, the top surface portion 340 provided adjacent to the supplying portion 200, and the mounting portion 210 positioned on the top surface portion 340 are exposed. Then, the toner pack 10 is inserted into the exposed supplying portion 200.

Here, the whole of the image forming apparatus 1 and the toner pack 10 is called an image forming system 1A.

Part (a) of FIG. 7 shows a state in which the toner pack 10 is inserted into the supplying portion 200. Part (b) of FIG. 7 shows a state in which the gripping portion 210a is moved from the initial position to the supplying position. The toner pack 10 is inserted into the supplying portion 200 and the gripping portion 210a is moved from the initial position to the supplying position, so that a state in which supply of the toner from the toner pack 10 is formed. In that state, the toner is discharged from the toner pack 10 and is supplied to the accommodating portion 418.

After the toner supply is completed, the gripping portion 210a is returned to an original position. At this time, the receiving portion shutter 230 of the supplying portion 200 and the shutter member 11 of the toner pack 10 rotate together. Then, the receiving portion shutter 230 covers the receiving opening 220c and the shutter member 11 covers a discharge opening 13a of the toner pack 10 (described later). Then, lock between the supplying portion 200 and the toner pack 10 (engagement between the circumferential groove portion 11g and the base supporting portion 220e) is released (disengaged), so that removal of the toner pack 10 from the supplying portion 200 becomes possible. In other words, in order to demount the toner pack 10 from the image forming apparatus 1, there is a need to cover the discharge opening 13a with the shutter member 11.

### [Constitution of Toner Pack]

A constitution of the toner pack (toner supply container, toner supply cartridge) 10 will be described.

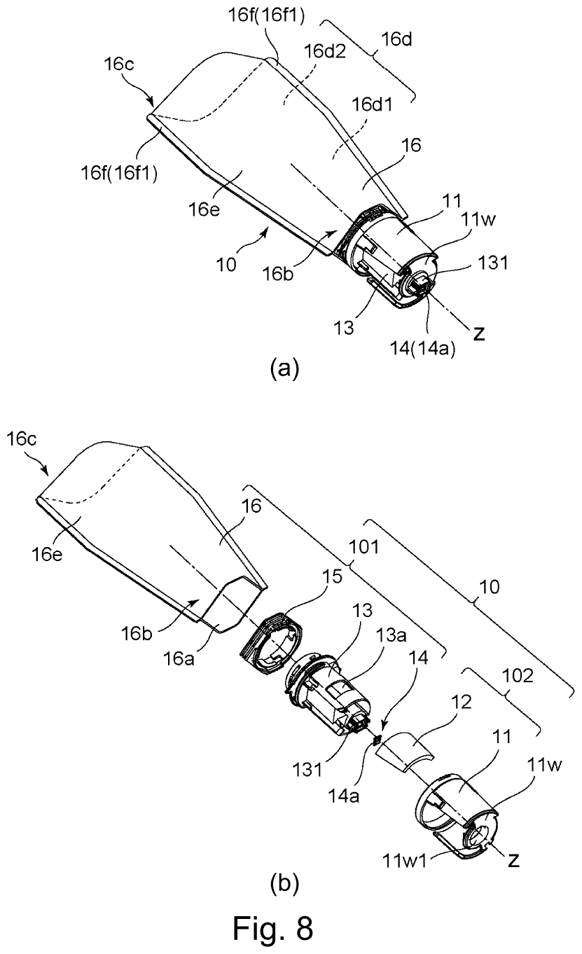

FIG. 8 includes perspective views of the toner pack 10 according to this embodiment. Part (a) of FIG. 8 is the perspective view of the toner pack 10 in an assembled state. Part (b) of FIG. 8 is the perspective view of the toner pack 10 in a disassembled state.

As shown in part (a) of FIG. 8 and part (b) of FIG. 8, the toner pack 10 includes the shutter member 11, a seal member 12, a supply base 13, a memory tag 14, an expansion member 15, and a pouch 16.

In the following, shapes of respective components (parts) and a relationship between the components will be described.

The pouch (bag) 16 as a container portion (container) for accommodating the toner and is a flexible container. Inside the pouch 16, an accommodating portion (space) 16a for accommodating the toner is formed.

The pouch 16 includes one end portion (first end portion) 16b and the other end portion (second end portion) 16c on a side opposite from the one end portion 16b. At the one end portion 16b, an opening 16a for permitting discharge of the toner from the accommodating portion 16d is formed. In this embodiment, a first direction is parallel to a direction of a rotational axis z of the shutter member 11 (described later). Further, in this embodiment, a longitudinal direction of the toner pack 10 is a direction parallel to the first direction. That is, a length of the toner pack 10 is longer as a length with respect to the first direction than a length thereof with respect to a direction perpendicular to the first direction.

The accommodating portion 16d includes a first accommodating portion 16d1 and a second accommodating portion 16d2 connected to the first accommodating portion 16d1. In this embodiment, the first accommodating portion 16d1 has a shape narrowing toward the opening portion 16a and is formed so that the toner is easy to move toward the opening portion 16a.

The pouch 16 can be deformed so as to compress the accommodating portion 16d from outside toward an inside of the pouch 16, and by this, discharge of the toner T is promoted. The pouch 16 can be deformed toward the direction perpendicular to the first direction so that opposing walls (part of a sheet portion 16e described later) contact each other. For facilitating the toner supply, a force for discharging the toner by deforming the pouch 16 may preferably be small.

In this embodiment, the toner pack 10 assumes the same attitude as an attitude when the toner pack 10 is mounted in the image forming apparatus 1 and is used, and the pouch 16 is deformed as described above in a state in which the toner is capable of being discharged from the discharge opening 13a (described later), so that the toner can be discharged. At this time, the pouch 16 may preferably be constituted so that the opposing walls contact each other via the accommodating portion 16d when a force of 40N or less acts in a direction perpendicular to the rotational axis z at least at a part of the accommodating portion 16d. More preferably, the pouch 16 is constituted so that the opposing walls contact each other via the accommodating portion 16d when a force of 10N or less (more preferably 5N or less) acts in the direction perpendicular to the rotational axis z at least at a part of the accommodating portion 16d.

In this embodiment, the pouch 16 includes the sheet portion 16e for forming the accommodating portion 16d. A thickness of the sheet portion 16e may preferably be 500 μm or less (more preferably 200 μm or less). In this embodiment, the sheet portion 16e is a sheet made of polypropylene having a thickness of 100 μm or less. The pouch 16 is formed in a bag shape by subjecting the sheet portion 16e to thermal welding or the like. Incidentally, a form of the pouch 16 is not limited to this, and a material of the sheet portion 16e may be polyethylene, polyethylene terephthalate, or the like.

The pouch 16 includes an overlapping portion 16f formed by causing parts of the sheet portion 16e to overlap with each other. In this embodiment, the overlapping portion 16f is formed by subjecting the sheet 16e to thermal welding. The overlapping portion 16f includes a side (surface) overlapping portion 16f1 disposed on a side surface of the pouch 16. The pouch 16 may be formed by folding a single sheet portion 16e or may be formed by a plurality of sheets 16e.

With respect to a direction perpendicular to the first direction, a size of the other end portion 16c of the pouch 16 is larger than a size of a tip (end) portion of a substrate installation portion 131 (described later). When the toner pack 10 is placed on a horizontal surface in an attitude such that the other end portion 16c is positioned at a bottom with respect to a vertical direction, the toner pack 10 can stand by itself. At this time, the attitude of the toner pack 10 is an attitude opposite to the attitude of the toner pack 10 when the toner pack 10 is mounted to the image forming apparatus 1. As a result thereof, the memory tag 14 is positioned above the other end portion 16c, so that the toner pack 10 can be placed in a state in which the memory tag 14 is spaced from a surface where the toner pack 10 is placed.

The pouch 16 is reinforced by the overlapping portion 16f. The side overlapping portion 16f1 extends in the first direction. As a result, when the toner pack 10 is placed with the other end portion 16c down, the toner pack 10 can be stably placed, and in addition, falling-down of the pouch 16 due to deformation of the toner pack 10 is suppressed.

To the opening 16a of the pouch 16, the expansion member (expansion portion, end portion holding portion, annular portion) 15 is mounted. The expansion member 15 is a resin member formed in a substantially hexagonal shape at an outer peripheral surface and is connected to the opening portion 16a of the pouch 16. By this, the flexible pouch 16 can maintain a state in which the opening portion 16a is open by the expansion member 15. The expansion member 15 has an annular shape such that a hole is formed through which the toner passes. The expansion member 15 is fixed to the supply base 13 so that the opening portion 16a and the discharge opening 13a communicate with each other as described later.

A connecting method between the expansion member 15 and the pouch 16 may be any method, and for example, it is possible to use a connecting method using various adhesives such as a hot melt, a connecting method in which the pouch 16 is thermally welded to the expansion member 15, and the like. Incidentally, the shape of the outer peripheral surface of the expansion member 15 may preferably be a shape such that the expansion member 15 is liable to slip when the user grips the expansion member 15 and may preferably be a polygonal shape. In this embodiment, a structure of the outer peripheral surface of the expansion member 15 has a substantially hexagonal shape. By this, the opening portion 16a of the pouch 16 is also deformed along the outer peripheral surface of the expansion member 15 and is a hexagon in shape.

With respect to the first direction, on an end side of the pouch 16, the supply base (discharging portion, discharging member, toner guiding portion, container receiving portion) 13 is disposed. The supply base 13 has a function as a portion-to-be-inserted (portion-to-be-supported, portion-to-be-mounted) inserted into and supported by the image forming apparatus when the toner pack 10 is mounted to the image forming apparatus 1. In this embodiment, the supply base 13 is mounted to the one end portion of the pouch 16 via the expansion member 15. However, the expansion member 15 and the supply base 13 can also be integrally formed. That is, the supply base 13 is caused to have a function of the expansion member 15, and may be directly connected to the pouch 16.

To the supply base 13, the shutter unit 102 including the shutter member 11 is mounted. The shutter member 11 is a resin component which is formed so as to cover an outer periphery of the supply base 13 and which has a substantially cylindrical shape, and is supported by the supply base 13 in a rotatable state at a predetermined phase. As shown in part (a) of FIG. 8 and part (b) of FIG. 8, a rotational axis of the shutter member 11 relative to the supply base 13 is a rotational axis (first axis) z. The rotational axis z extends in the first direction.

The supply base 13 is provided with the toner discharge opening (discharge opening) 13a which is a through hole for permitting discharge of the toner accommodated in the pouch 16 and with the substrate installation portion (projected portion) 131 to which the memory tag 14 is mounted.

Inside the supply base 13, the toner path 13c (described later) is formed, which is disposed between the pouch 16 and the discharge opening 13a and which is for permitting passing of the toner.

The substrate installation portion 131 is positioned at the top portion of the toner pack 10 with respect to the direction (first direction) parallel to the rotational axis z. In this embodiment, the memory tag 14 is fixed in a position where the memory tag 14 overlaps with the rotational axis z.

The substrate installation portion 131 projects toward a direction of the rotational axis z. On the other hand, the shutter member 11 is provided with a crossing wall 11w which extends in a direction crossing the direction of the rotational axis z and which includes a through hole 11w1. The through hole 11w1 exposes an electroconductive portion 14a to outside of the toner pack 10. In this embodiment, the substrate installation portion 131 is inserted into the through hole 11w1, so that the electroconductive portion 14a is exposed to the outside of the toner pack 10.

The memory tag 14 is fixed to the substrate installation portion 131 with use of a means such as a double-side tape or an adhesive. However, as a method for mounting the memory tag 14 on the substrate installation portion 131, press-fitting or snap-fitting may also be used.

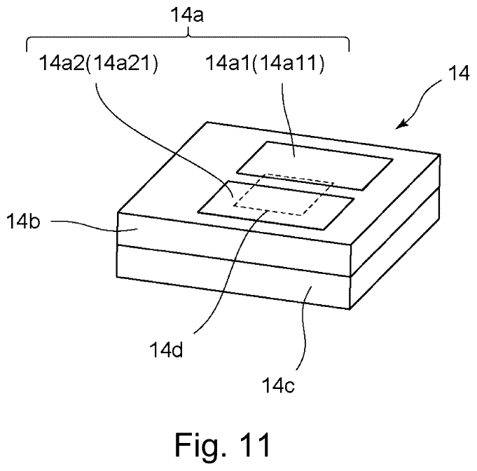

Further, as described later, the memory tag 14 includes the electroconductive portion 14a which is an electric contact (see FIG. 11). The electroconductive portion 14a of the memory tag 14 is disposed so as to be exposed to the outside of the toner pack 10 with respect to a direction parallel to the rotational axis z.

To the shutter member 11, the seal member 12 is mounted. The seal member 12 is positioned in a region between the supply base and the shutter member 11 with respect to a radial direction relative to the rotational axis z, and is applied and fixed to an inner peripheral surface of the shutter member 11 with use of an unshown double-side tape.

The toner pack 10 in this embodiment is capable of promoting discharge of the toner from the toner pack 10 by deforming the pouch 16. For that reason, the pouch 16 may preferably employ a flexible structure (low-rigidity structure). On the other hand, in order to stably mount the toner pack 10 to the image forming apparatus 1, the supply base 13 may preferably employ a structure higher in rigidity than the pouch 16. That is, when a force with the same magnitude acts on an object, deformation of the pouch 16 is larger than deformation of the supply base 13.

When the electroconductive portion 14a of the memory tag 14 is positioned by the pouch 16, which is lower in rigidity than the supply base 13, the position of the electroconductive portion 14a of the memory tag 14 is liable to be deviated. In this embodiment, the electroconductive portion 14a of the memory tag 14 is positioned by the supply base 13, whereby the position of the electroconductive portion 14a of the memory tag 14 is not readily deviated. As a result, for example, the electroconductive portion 14a of the memory tag 14 can be accurately positioned relative to the image forming apparatus 1.

In the following, the supply base 13, the memory tag 14, the expansion member 15, and the pouch 16 which are integrally connected are referred to as a supply unit 101, and the shutter member 11 and the seal member 12 are referred to as the shutter unit 102. That is, the toner pack 10 includes the supply unit 101 and the shutter unit 102.

In this embodiment, with respect to the first direction, the supply base 13 and the shutter unit 102 are disposed on the one end portion side of the toner pack 10, and the pouch 16 is disposed on the other end portion side of the toner pack 10.

Incidentally, in this embodiment, the shutter unit 102 includes the seal member 12 for sealing between the shutter member 11 and the supply base 13. However, a seal member provided with a hole through which the toner passes, so that the seal member seals between the shutter member 11 and the supply base 13, so that the seal member 12 can be omitted from the shutter unit 102. In this case, the shutter unit 102 does not include the seal member 12.

Further, a portion including the supply base 13, the memory tag 14, and the shutter unit 102 can be called a mounting unit detachably mountable to the image forming apparatus 1. The mounting unit is mountable to the pouch 16. In this embodiment, the pouch 16 and the mounting unit are connected to each other via the expansion member 15.

### <Structures and Operations of Shutter Unit and Supply Base>

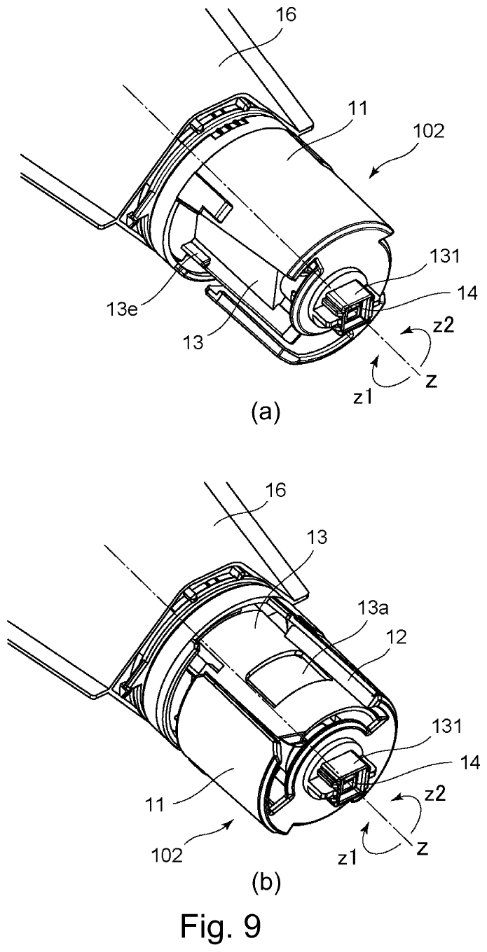

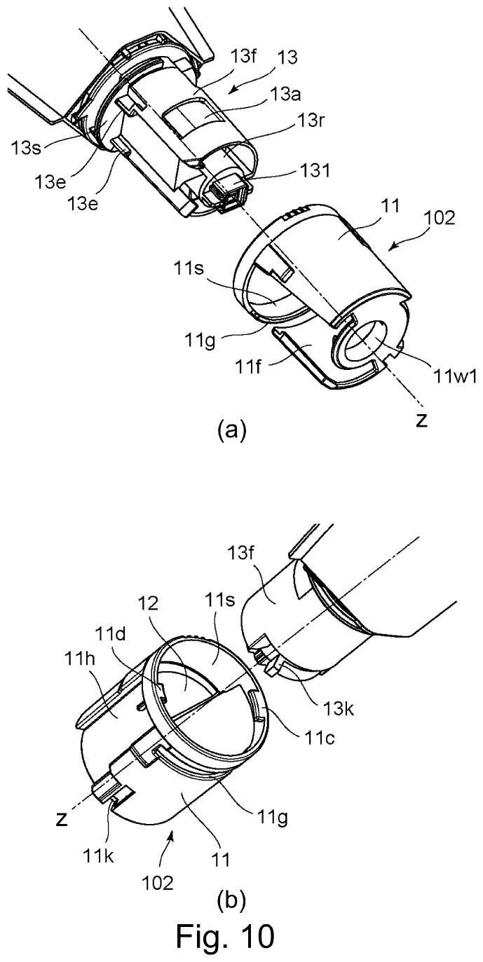

Structures and operations of the shutter unit (shutter) 102 and the supply base 13 will be described using part (a) of FIG. 9, part (b) of FIG. 9, part (a) of FIG. 10, and part (b) of FIG. 10.

FIG. 9 includes perspective views of the toner pack 10, in which part (a) of FIG. 9 shows a state in which the shutter unit 102 is in a closed position where the shutter unit 102 seals the discharge opening 13a, and part (b) of FIG. 9 shows a state in which the shutter unit 102 is in a retracted position. FIG. 10 (part (a) of FIG. 10, part (b) of FIG. 10) includes perspective views for illustrating the structures of the shutter unit 102 and the supply base 13.

The shutter unit 102 is rotatable around the rotational axis z with the rotational axis z as a center relative to the supply unit 101. That is the rotational axis of the shutter member 11 and the seal member 12 is the rotational axis z.

The shutter unit 102 covers the discharge opening 13a and is configured to be movable between a closed position (cover position, first position) where discharge of the toner is restricted and a retracted position (second position, electroconductive portion position) retracted from the closed position. In this embodiment, when the shutter unit 102 is in the second position, the discharge opening 13a is exposed toward outside of the toner pack 10, so that discharge of the toner from the discharge opening 13a is permitted. The second position can also be called an open position where the discharge opening 13a is opened.

In part (a) of FIG. 9 and part (b) of FIG. 9, z1 direction is a movement direction in which the shutter unit 102 moves from the first position to the second position, and z2 direction is a movement direction in which the shutter unit 102 moves from the second position to the first position.

In this embodiment, a rotation angle (a difference between the first position and the second position) of the shutter unit 102 around the rotation axis z can be made 180 degrees or less. The rotation angle of the shutter unit 102 around the rotation axis z can be made 45 degrees or more. In this embodiment, the rotation angle of the shutter unit 102 is about 90 degrees.

The discharge opening 13a opens toward a direction (preferably a direction perpendicular to the first direction) crossing the first direction. In other words, the discharge opening 13a is disposed toward the direction (preferably the direction perpendicular to the first direction) crossing the first direction.

Next, a relationship between portions of the shutter unit 102 and the supply base 13 will be described using part (a) of FIG. 10 and part (b) of FIG. 10.

The supply base 13 is provided with the above-described discharge opening 13a, the substrate installation portion 131, and in addition, an outer peripheral portion 13f, a main assembly-engaging portion 13e, a shaft portion 13r, a flange portion 13s, and a claw portion (shutter restricting portion) 13k.

The outer peripheral portion 13f (second surface, opening-forming portion, opening-forming wall) 13f is provided with the discharge opening 13a. The surface of the outer peripheral portion 13f faces toward the direction (preferably the direction perpendicular to the first direction) crossing the first direction. That is, a direction normal to the outer peripheral portion 13f is the direction (preferably the direction perpendicular to the first direction) crossing the first direction. In this embodiment, the outer peripheral portion 13f extends along the direction parallel to the first direction and has an arcuate surface (arcuate shape). That is, a generatrix direction of the arcuate surface is the direction parallel to the first direction. A center of the arcuate surface coincides with the rotational axis z.

The main assembly-engaging portion 13e is a projection provided relative to the discharge opening 13a with a predetermined gap on a side surface rotated in the Z2 direction by about 90 degrees, and engages with a part of the image forming apparatus 1 when the toner pack 10 is mounted to the image forming apparatus 1.

The shaft portion 13r has an arcuate surface (arcuate shape) having a shorter radius than the outer peripheral portion 13f. The flange portion 13s has an arcuate surface (arcuate shape) having a longer radius than the outer peripheral portion 13f. In this embodiment, a center of the arcuate surface of the shaft portion 13r and a center of the arcuate surface of the flange portion 13s coincide with the rotational axis z. Generatrix directions of these arcuate surfaces are also directions parallel to the first direction.

The claw portion 13k has flexibility so as to be movable in a radial direction of a circle with the rotational axis z as a center. A tip (end) portion of the claw portion 13k is movable between a position outside the outer peripheral surface 13f and a position inside the outer peripheral surface 13f in the radial direction of the circle with the rotational axis z as the center.

The shutter member 11 is a resin member having a substantially cylindrical shape. The shutter member 11 is provided with the through hole 11w1 and a bearing portion 11s. Further, on the shutter member 11, a locking claw 11c and a locking claw 11d, an exposure portion 11f, a circumferential groove portion 11g, a locking groove (shutter(-side) portion-to-be-restricted) 11k, and an outer periphery recessed portion 11h are formed.

The through hole 11w1 and the bearing portion 11s engage with the shaft portion 13r and the flange portion 13s which are provided on the supply base 13. By this, the shutter member 11 and the shutter unit 102 including the seal member 12 become rotatable around the supply base 13 relative to the rotational axis z.

The locking claw 11c and the locking claw 11d engage with the flange portion 13s, and restrict movement of the shutter member 11 in the first direction relative to the supply base 13.

The exposure portion 11f, the circumferential groove portion 11g, and the outer periphery recessed portion 11h are formed at an outer peripheral portion of the shutter member 11. The exposure portion 11f has a rectangular shape, and exposes the discharge opening 13 to the outside of the toner pack 10 when the shutter unit 102 is in the second position.

The circumferential groove portion 11g is a groove extending in the direction crossing a direction of the rotational axis z. In this embodiment, the circumferential groove portion 11g extends toward a circumferential direction (rotational direction of the shutter member 11) of the shutter member 11, and is formed in a part of a region (about) 90° of the shutter member 11. One end of the circumferential groove portion 11g is connected to the exposure portion 11f.

The outer periphery recessed portion 11h is provided on a side opposite from the exposure portion 11f with respect to the circumferential direction of the shutter member 11 with the rotational axis z sandwiched therebetween. The outer peripheral recessed portion 11h is a surface recessed more toward an inside of the shutter member 11 than the outer periphery of the shutter member 11 with respect to the radial direction of the circle with the rotation axis z as the center.

The locking groove 11k is provided in a position where the claw portion 13k of the supply base 13 engages with the locking groove 11k when the shutter unit 102 is in the first position. The claw portion 13k and the locking groove 11k engage with each other, so that rotation of the shutter unit 102 is restricted. By this, leakage of the toner due to unintended movement of the shutter unit 102 to the second position by the user is prevented. In the case where the shutter unit 102 is rotated, the shutter unit 102 is displaced in a direction approaching the rotational axis z by applying an external force to the claw portion 13k, so that engagement between the claw portion 13k and the locking groove 11k is released.

The seal member 12 is a sheet-like member which is constituted by a material such as an elastically deformable urethane foam or nonwoven cloth and which has a predetermined thickness. A surface of the seal member 12 on the shutter member 11 side is fixed to the inner peripheral surface of the shutter member 11 by a double-side tape or the like. By this, the seal member 12 is rotatable integrally with the shutter member 11.

Further, the seal member (sealing portion) 12 is pressed to the outside and is deformed by the outer peripheral portion 13f in a direction approaching the shutter member 11, i.e., a radial direction perpendicular to a direction of the rotational axis z in a state in which the shutter member 11 is assembled with the supply base 13. That is, the seal member 12 is in a state in which the seal member 12 is pressed against the outer peripheral portion 13f by a predetermined pressure. By this, the seal member12 is compressed between the outer peripheral portion 13f and the shutter member 11, so that toner leakage from a boundary between the seal member 12 and the outer peripheral portion 13f of the supply base 13 can be suppressed.

In this embodiment, the seal member 12 is an opposing portion opposing the discharge opening 13a when the shutter unit 102 is in the first position.

Incidentally, a constitution of the opposing portion of the shutter unit 102 is not limited to the above-described constitution. For example, a constitution in which when the shutter unit 102 is in the first position, a part of the shutter member 11 opposes the discharge opening 13a may be employed. In that case, the part of the shutter member 11 has a function as the opposing portion.

As shown in part (a) of FIG. 9, when the shutter unit 102 is in the first position, the seal member 12 covers the discharge opening 13a. By this, leakage of the toner accommodated in the pouch 16 from the discharge opening 13a to outside of the toner pack 10 is prevented. Further, as shown in part (b) of FIG. 9, when the shutter unit 102 is in the second position, the exposure portion 11f of the shutter member 11 in a position corresponding to the discharge opening 13a. For that reason, the discharge opening 13a is exposed to outside of the toner pack 10, so that the toner can be discharged from the discharge opening 13a to the outside of the toner pack 10.

### <Constitution of Memory Unit>

Next, a constitution of the memory unit will be described using FIG. 11. FIG. 11 is an illustration of the memory unit.

As shown in FIG. 11, the memory tag 14 as the memory unit in this embodiment includes a memory (storing element) 14d for storing information on the toner pack 10 and an electroconductive portion (electrode portion, interface portion) 14a electrically connected to the memory 14d, and is constituted as an example of a memory portion. The electroconductive portion 14a includes a first electrode (first terminal, first memory electrode) 14a1 and a second electrode (second terminal, second memory electrode) 14a2, and the first electrode 14a1 and the second electrode 14a2 are electrically connected to the memory 14d.

The memory tag 14 is provided with a holding portion (holding substrate) 14b for holding the electroconductive portions 14a (first electrode 14a1, second electrode 14a2). The memory tag 14 is provided with a protective portion 14c for protecting the memory 14d by covering the memory 14d. In this embodiment, the electroconductive portion 14a is disposed on one surface (front surface) of the holding portion 14b, and the memory 14d is disposed on the other surface (back surface) of the holding portion 14b.

The first electrode 14a1 has a first exposed surface 14a11 exposed to the outside of the toner pack 10. The second electrode 14a2 has a second exposed surface 14a21 exposed to the outside of the toner pack 10.

The memory tag 14 in this embodiment is a plate-like member of 5.5 mm×5 mm in area and 1.4 mm in thickness. The holding portion 14b and the protective portion 14c are integrated with each other. The memory tag 14 has a two-layer structure formed by the holding portion 14b and the protective portion 14c. The holding portion 14b and the protective portion 14c can be said as being a part of a substrate portion (substrate) provided with the electroconductive portion 14a.

In the memory 14d, information on the toner pack is stored. In the information on the toner pack 10, information on a lot of the toner pack 10 and information on an amount and a characteristic of the toner accommodated in the toner pack 10 are included.

In the memory 14d, information on the image forming apparatus 1 to which the toner pack 10 is mounted is stored in some cases. In the information on the image forming apparatus 1, information used for control of the image forming apparatus 1 by a controller 399 is included. The controller 399 for the image forming apparatus 1 is electrically connected to the memory 14d through the electroconductive portion 14a, so that the controller 399 reads the information stored in the memory 14d and controls the image forming apparatus 1.

In this embodiment, the number of electrodes disposed in the electroconductive portion 14a is two, but the present invention is not limited thereto. For example, the electroconductive portion 14a may include three or more electrodes. Further, one electrode is disposed in the holding portion, and another electrode may be disposed in another portion.

### <Arrangement of Memory Unit>

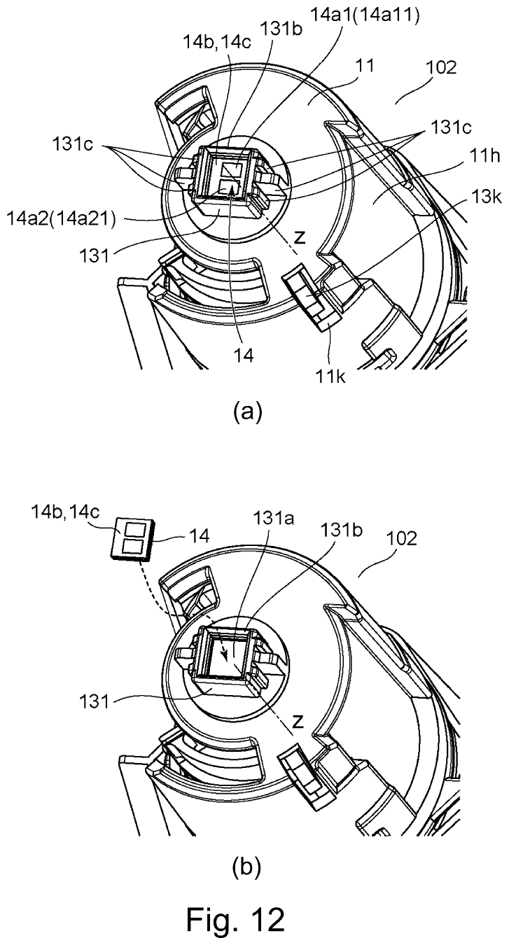

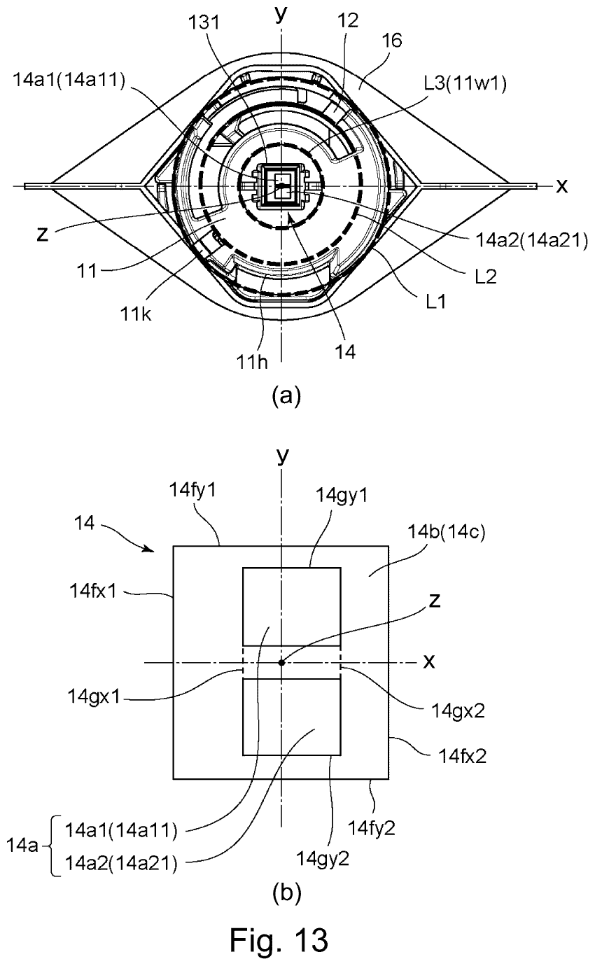

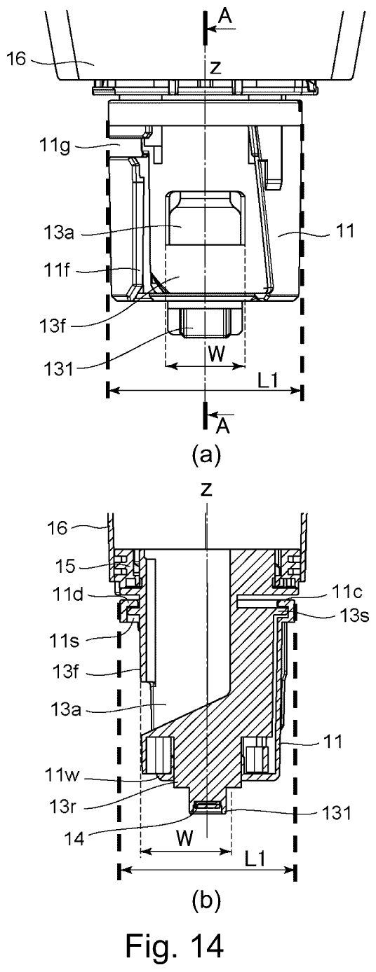

Arrangement of the memory unit will be described using part (a) of FIG. 12, part (b) of FIG. 12, part (a) of FIG. 13, part (b) of FIG. 13, part (a) of FIG. 14, and part (b) of FIG. 14.

FIG. 12 includes perspective views showing a tip (end) portion of the toner pack 10. Part (a) of FIG. 12 is the perspective view of the tip portion of the toner pack 10 with which the memory tag 14 is assembled. Part (b) of FIG. 12 is the perspective view of the tip portion of the toner pack 10 before the memory tag 14 is assembled with the toner pack 10. FIG. 13 includes perspective views for illustrating the arrangement of the memory unit in this embodiment. Part (a) of FIG. 13 is a bottom view of the toner pack 10. Part (b) of FIG. 13 is in an enlarged view of the memory tag 14. FIG. 14 includes views for illustrating the arrangement of the memory unit in this embodiment. Part (a) of FIG. 14 is a side view of the toner pack 10. Part (b) of FIG. 14 is a sectional view of the toner pack 10.

As shown in part (a) of FIG. 12, the substrate installation portion 131 is provided at a tip of the toner pack 10 in a direction of the rotational axis z. Further, as shown in part (b) of FIG. 12, the substrate installation portion 131 is provided with an installation surface (installation portion, positioning surface, positioning portion) 131a on which the memory tag 14 is adhesively fixed. In this embodiment, the installation surface 131a positions the electroconductive portions 14a (first electrode 14a1, second electrode 14a2) via a substrate including the protective portion 14c and the holding portion 14b. That is, the substrate of the memory tag 14 is fixed on the installation surface 131a and is positioned by the installation surface 131a, whereby the electroconductive portion 14a is positioned relative to the supply base 13. In this embodiment, the installation surface 131a positions the electroconductive portion 14a with respect to the first direction and a direction perpendicular to the first direction.

In a state in which the memory tag 14 is positioned by the installation surface 131a, the first exposed surface 14a11 of the first electrode 14a1 is disposed along a direction (preferably a direction perpendicular to) crossing the first direction. In other words, in the state in which the memory tag 14 is positioned, the first exposed surface 14a11 of the first electrode 14a1 is disposed on a flat plane (imaginary flat plane) extending along the direction (preferably the direction perpendicular to) crossing the first direction.

In this state, the first exposed surface 14a11 faces the first direction. That is, a normal direction to the first exposed surface 14a11 crosses (preferably be perpendicular to) the direction perpendicular to the first direction. The first exposed surface 14a11 is exposed to outside of the toner pack 10. In this embodiment, with respect to the first direction, on a back surface of the first exposed surface 14a11, the supply base 13 and the pouch 16 are disposed. Further, the first exposed surface 14a11 extends in the direction (preferably the direction perpendicular to) crossing the first direction, while the outer peripheral portion 13f of the supply base 13 extends in the direction crossing (preferably be perpendicular to) a direction in which the first exposed surface 14a11 extends.

Similarly, in a state in which the memory tag 14 is positioned by the installation surface 131a, the second exposed surface 14a21 of the second electrode 14a2 is disposed along a direction (preferably a direction perpendicular to) crossing the first direction. In other words, in the state in which the memory tag 14 is positioned, the second exposed surface 14a21 of the second electrode 14a2 is disposed on a flat plane (imaginary flat plane) extending along the direction (preferably the direction perpendicular to) crossing the first direction.

In this state, the second exposed surface 14a21 faces the first direction. That is, a normal direction to the second exposed surface 14a21 crosses (preferably be perpendicular to) the direction perpendicular to the first direction. The second exposed surface 14a21 is exposed to outside of the toner pack 10. In this embodiment, with respect to the first direction, on a back surface of the second exposed surface 14a21, the supply base 13 and the pouch 16 are disposed. The outer peripheral portion 13f of the supply base 13 extends in the direction crossing (preferably be perpendicular to) a direction in which the second exposed surface 14a21 extends.

In this embodiment, the second exposed surface 14a21 and the first exposed surface 14a11 are disposed on the same flat plane. However, with respect to the first direction, a position of the second exposed surface 14a21 and a position of the first exposed surface 14a11 may be different from each other.

Here, around the memory tag 14, with respect to the first direction, a most tip end portion 131b as a projected portion projecting more than the first exposed surface 14a11 and the second exposed surface 14a21 is provided. The installation surface 131a is positioned inside the most tip end portion 131b of the substrate installation portion 131 with respect to the first direction.

As regards the most tip end portion 131b, with respect to the first direction, a distance from the most tip end portion 131b to the installation surface 131a is longer than 1.4 mm which is a thickness (equal to a thickness of the substrate) of the memory tag 14. By this, when the memory tag 14 is fixed on the installation surface 131a, a relationship such that the most tip end portion 131b of the substrate installation portion 131 projects toward the tip side more than the electroconductive portion 14a with respect to the first direction is formed. Accordingly, it is possible to prevent damage of the electroconductive portion 14a generated by contact of the electroconductive portion 14a by a user not being careful or contact of an article with the electroconductive portion 14a during handling by the user.

Further, the substrate installation portion 131 includes a projected wall 131c extending in a direction crossing the first direction. In this embodiment, a plurality of projected walls 131c are provided with the memory tag 14 sandwiched therebetween. The projected wall 131c has a function as a connector positioning portion (apparatus-side contact point positioning portion) which engages with a connector 250 described later and which is for positioning the connector 250.

Part (a) of FIG. 13 is a view in which the toner pack 10 is viewed along the direction (first direction) of the rotational axis z.

In this embodiment, as viewed along the first direction, the first exposed surface 14a11 and the second exposed surface 14a21 are disposed inside a first imaginary circle L1 passing through an outer end (outermost portion) of the shutter unit 102 with the rotational axis z as the center. Here, the outer end of the shutter unit 102 refers to a portion most away from the rotational axis z with respect to the direction perpendicular to the rotational axis z. In this embodiment, the outer end of the shutter unit 102 coincides with an outer end (portion most away from the rotational axis z) of the shutter member 11. As viewed along the first direction, the whole of the shutter unit 102 is positioned inside the imaginary circle L1.

As viewed along the first direction, the first electroconductive portion surface 14a11 and the second exposed surface 14a21 are positioned inside a second imaginary circle L2 passing through an opposing portion opposing the discharge opening 13a with the rotational axis z as the center. As described above, in this embodiment, the opposing portion is a surface (surface contacting a periphery (outer peripheral portion) of the discharge opening 13a) opposing the discharge opening 13a of surfaces of the seal member 12.

Further, as viewed along the first direction, the first exposed surface 14a11 and the second exposed surface 12a21 are disposed inside a third imaginary circle L3 passing through an inner end (innermost portion) of the shutter unit 102 with the rotational axis z as the center. Here, the inner end of the shutter unit 102 refers to a portion closest to the rotational axis z with respect to the direction perpendicular to the rotational axis z. In this embodiment, the inner end of the shutter unit 102 coincides with an inner wall surface of the through hole 11w1 of the shutter member 11. That it, the inner end of the shutter unit 102 coincides with an inner end (portion closest to the rotational axis z) of the shutter member 11. As viewed along the first direction, the whole of the shutter unit 102 is positioned outside the imaginary circle L3.

According to a constitution of this embodiment, the first exposed surface 14a11 and the second exposed surface 14a21 can be disposed in a space-saving manner.

In this embodiment, the electroconductive portion 14a is disposed inside the first imaginary circle L1, the second imaginary circle L2, and the second imaginary circle L3. Further, the holding portion 14b is disposed inside the first imaginary circle L1, the second imaginary circle L2, and the second imaginary circle L3. Further, the whole of the memory tag 14 including the memory 14d is disposed inside the first imaginary circle L1, the second imaginary circle L2, and the second imaginary circle L3.

Part (b) of FIG. 13 is an enlarged view in the neighborhood of the memory tag 14. As viewed along the first direction, the rotational axis z is positioned between the first exposed surface 14a11 and the second exposed surface 14a21.

As viewed along the first direction, with respect to a first perpendicular direction x perpendicular to the first direction, the holding portion 14b of the memory tag 14 includes a first substrate end 14fx1 and a second substrate end 14fx2 opposite from the first substrate end 14fx1. As viewed along the first direction, with respect to a second perpendicular direction y perpendicular to the first direction and the first perpendicular direction x, the holding portion 14b of the memory tag 14 includes a third substrate end 14fy1 and a fourth substrate end 14fy2 opposite from the third substrate end 14fy1.

With respect to the first perpendicular direction x, the rotational axis z is positioned between the first substrate end 14fx1 and the second substrate end 14x2. With respect to the first perpendicular direction x, the whole of the electroconductive portion 14a is positioned between the first substrate end 14fx1 and the second substrate end 14fx2. With respect to the second perpendicular direction y, the rotational axis z is positioned between the third substrate end 14fy1 and the fourth substrate end 14fy2. With respect to the second perpendicular direction y, the whole of the electroconductive portion 14a is positioned between the third substrate end 14fy1 and the fourth substrate end 14fy2. Incidentally, as viewed along the first direction, with respect to the first perpendicular direction x, an outer configuration of the holding portion 14b coincides with an outer configuration of the protecting portion 14a.

As viewed along the first direction, with respect to the first perpendicular direction x, the electroconductive portion 14a of the memory tag 14 includes a first electroconductive portion end 14gx1 and a second electroconductive portion end 14gx2 opposite from the first electroconductive portion end 14gx1. As viewed along the first direction, with respect to the second perpendicular direction y, the electroconductive portion 14a of the memory tag 14 includes a third electroconductive portion end 14gy1 and a fourth electroconductive portion end 14gy2 opposite from the third electroconductive portion end 14gy1. The first electroconductive portion end 14gx1, the second electroconductive portion end 14gx2, the third electroconductive portion end 14gy1, and the fourth electroconductive portion end 14gy2 coincide with at least either one of end portions of the first exposed surface 14a11 and the second exposed surface 14a21.

With respect to the first perpendicular direction x, the rotational axis z is positioned between the first electroconductive portion end 14gx1 and the second electroconductive portion end 14gx2. With respect to the first perpendicular direction x, the whole of the electroconductive portion 14a is positioned between the first electroconductive portion end 14gx1 and the second electroconductive portion end 14gx2. With respect to the second perpendicular direction y, the rotational axis z is positioned between the third electroconductive portion end 14gy1 and the fourth electroconductive portion end 14gy2. With respect to the second perpendicular direction y, the whole of the electroconductive portion 14a is positioned between the third electroconductive portion end 14gy1 and the fourth electroconductive portion end 14gy2.

With respect to the direction perpendicular to the first direction, the holding portion 14b and the electroconductive portion 14a of the memory tag 14 are disposed in the neighborhood of the rotational axis z of the shutter unit 102. Accordingly, the holding portion 14b and the electroconductive portion 14a of the memory tag 14 and the shutter unit 102 can be disposed in a space-saving manner.

The shutter unit 102 is constituted so that the electroconductive portion 14a is exposed to outside of the toner pack 10. In this embodiment, the electroconductive portion 14a of the memory tag 14 is disposed at a portion close to the rotational axis z of the shutter unit 102, so that a degree of design freedom regarding the shape and the arrangement of the shutter unit 102 can be improved.

Part (a) of FIG. 14 is a side view of the toner pack 10 in which the toner pack 10 is viewed from above toward below in part (a) of FIG. 13. Part (b) of FIG. 14 is a sectional view of the toner pack 10 in a line A-A along the rotational axis z of part (a) of FIG. 14.

A fixing position of the memory tag 14 is in inside of a radius of rotation (radius of the imaginary circle L1) of the shutter member 11 projected in the first direction, illustrated by thick broken lines in FIG. 13. The radius of rotation of the shutter member 11 coincides with a radius of rotation of the shutter unit 102. The fixing position of the memory tag 14 is disposed inside also for a projection range W of the discharge opening 13a in the first direction as shown by thin broken lines in parts (a) and (b) of FIG. 14.

### [Constitution of Supplying Portion]

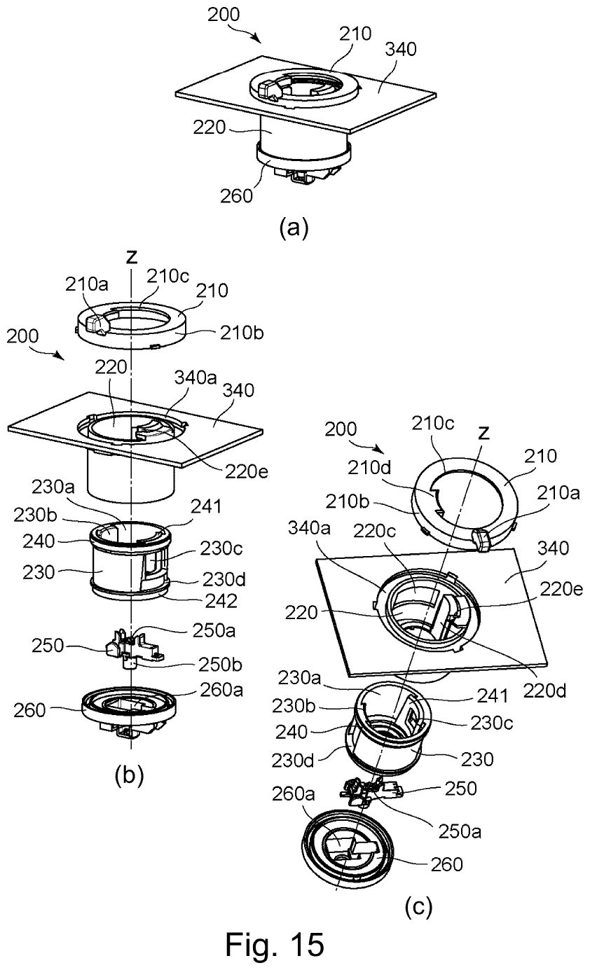

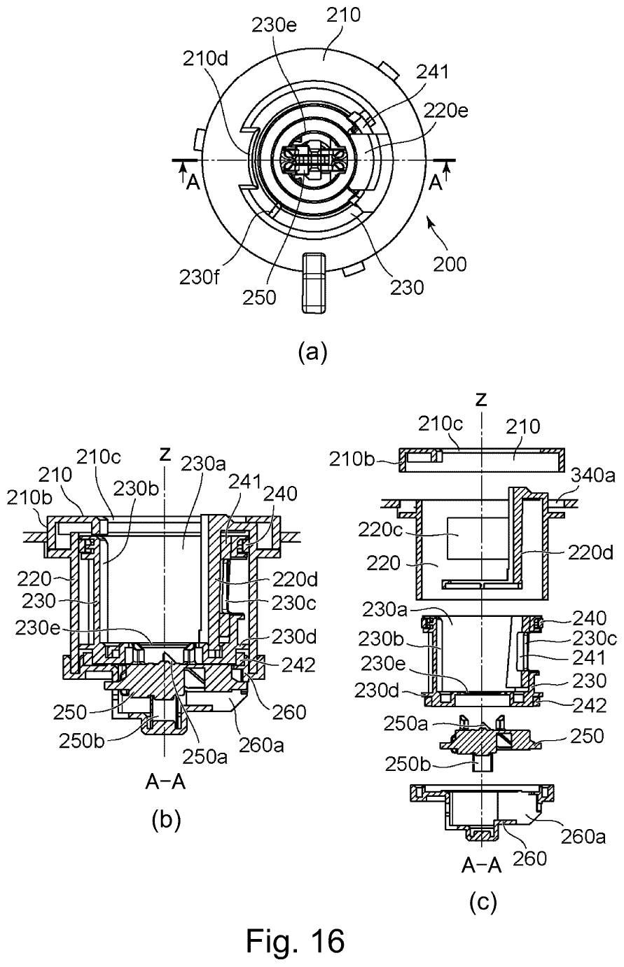

Next, the constitution of the supplying portion 200 will be described using FIG. 15 and FIG. 16.

FIG. 15 includes views for illustrating the constitution of the supplying portion 200. Part (a) of FIG. 15 is a partial perspective view of the supplying portion 200, and part (b) of FIG. 15 and part (c) of FIG. 15 are exploded perspective views in which the supplying portion 200 is viewed from directions different from each other. FIG. 16 includes views for illustrating the constitution of the supplying portion 200. Part (a) of FIG. 16 is a schematic view in which the supplying portion 200 is viewed from directly above the rotational axis z, part (b) of FIG. 16 is a sectional view along A-A direction shown in part (a) of FIG. 16, and part (c) of FIG. 16 is an exploded view of the supplying portion 200 in a cross section as viewed from a direction of part (b) of FIG. 16.

The supplying portion 200 is disposed on the top surface portion 340 and is provided with the mounting portion 210, the toner receiving portion 220, a receiving portion shutter 230, a shutter seal 240, a receiving seal 241, the connector 250, a receiving bottom 260, and a bottom seal 242.

The rotational axes shown in parts (a) to (c) of FIG. 15 and parts (a) to (c) of FIG. 16 are rotational axes of the receiving portion shutter 230 and the mounting portion 210 and coincide with the rotational axis z of the above-described shutter unit 102 in the state in which the toner pack 10 is mounted.

The mounting portion 210 includes a gripping portion 210a operated by the user, a ring portion 210b engaging with the top surface portion 340, a mounting hole 210c in which the toner pack 10 is mounted, and an engaging projection 210d engaging with the shutter member 11.

The top surface portion 340 is a part of the casing 72 and includes a guiding groove 340a.

The toner receiving portion 220 includes a receiving opening 220c, a seal inner wall 220d, and a base supporting portion 220e.

The receiving portion shutter 230 is a cylindrical component (part) and includes an inner peripheral portion 230a, a shutter engaging portion 230b, a shutter opening 230c, a flange portion 230d, a connecting hole 230e, and a claw releasing portion (restriction releasing portion) 230f. Further, to the receiving portion shutter 230, each of a shutter seal 240, a receiving seal 241, and a bottom seal 242 which are formed with a foam material such as a urethane foam is applied and fixed by a double-side tape.

The connector 250 includes a connector electrode 250a contacting the electroconductive portion 14a of the memory tag 14, and an urging spring 250b. The connector electrode 250a and the urging spring 250b are springs made of metal and have flexibility with respect to a direction along the rotational axis z. Further, the connector electrode 250a is electrically connected to the controller 399 of the image forming apparatus 1 by an unshown signal line. The connector 250 is a holding member for holding the connector electrode 250a.

The receiving bottom 260 includes a connector accommodating portion 260a and is fixed to the toner receiving portion 220.

Here, the mounting portion 210 is rotatable around the rotational axis z relative to the top surface portion 340 by being supported at the ring portion 210b by the guiding groove 340a provided in the top surface portion 340.

Further, the receiving portion shutter 230 is rotatable around the rotational axis z relative to the toner receiving portion 220 by being supported at the flange portion 230d by the toner receiving portion 220.

The shutter seal 240 is provided at an outer periphery of the receiving portion shutter 230 and contacts the toner receiving portion 220, so that the shutter seal 240 closes a gap between the receiving portion shutter 230 and the toner receiving portion 220. The receiving seal 241 is provided so as to surround a periphery of the shutter opening 230c at the inner peripheral portion 230a of the receiving portion shutter 230 and contacts the seal inner wall 220d of the toner receiving portion 220. The bottom seal 242 is provided at a lower portion of the flange portion 230d and closes a gap between the receiving portion shutter 230 and the receiving bottom 260.

Further, on a bottom side of the receiving portion shutter 230, the connecting hole 230e penetrating through the receiving portion shutter 230, and through the connecting hole 230e, the connector electrode 250a of the connector 250 is exposed toward above in the first direction. Further, at this time, the connector 250 is in a state in which the connector 250 is supported by the receiving bottom 260, and the urging spring 250b is in a compressed state. Accordingly, by a force of the urging spring 250b, the connector 250 is urged upward in the direction of the rotational axis z. The connector 250 engages with the projected wall 131d of the supply base 131, and is positioned with respect to the direction perpendicular to the first direction. That is, the projected wall 131 has a function as an electrode positioning portion for positioning the connector electrode 250a.

[Supply of Toner from Toner Pack]

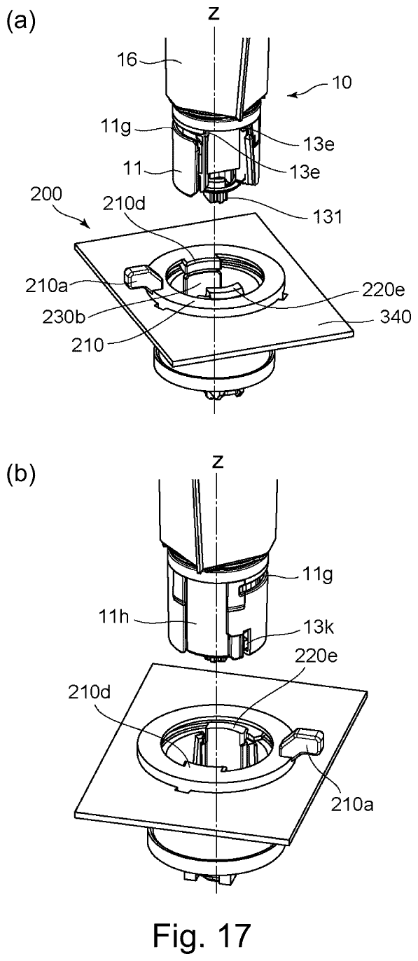

Next, a supplying operation of the toner from the toner pack 10 toward the image forming apparatus 1 will be described using FIG. 17 to FIG. 21.

FIG. 17 (part (a) of FIG. 17, part (b) of FIG. 17) includes perspective views for illustrating mounting of the toner pack 10. Part (a) of FIG. 17 and part (b) of FIG. 17 are the perspective views in which states before the toner pack 10 is inserted into the supplying portion 200 are viewed from different directions.

The toner pack 10 is mounted into the supplying portion 200 so that the supply base 13 is positioned on a side downstream of the pouch 16 with respect to a mounting direction thereof into the supplying portion 200. That is, in this embodiment, the toner pack 10 is mounted so that the electroconductive portion 14a faces the downstream side in the mounting direction. Accordingly, the first exposed surface 14a11 and the second exposed surface 14a21 are disposed so as to face the downstream side of the mounting direction and is exposed toward the downstream side of the mounting direction.

In this embodiment, the toner pack 10 is mounted to the supplying portion 200 along the rotational axis z. Further, in this embodiment, the toner pack 100 is mounted so that the direction of the rotational axis z becomes parallel to the vertical direction.

When the toner pack 10 is mounted to the supplying portion 200, the main assembly(-side) engaging portion 13e of the supply base 13 and the base supporting portion 220e of the toner receiving portion 220 engage with each other. By this, relative to the image forming apparatus 1, rotation of the supply base 13, the expansion member 15, and the pouch 16 around the rotational axis z is restricted. Further, at the same time, the outer peripheral recessed portion 11h of the shutter member 11 engages with each of the engaging projection 210d of the mounting portion 210 and the shutter engaging portion 230b of the receiving portion shutter 230.

In the receiving portion shutter 230, the claw releasing portion 230f shown in part (a) of FIG. 16 is provided in a position corresponding to the claw portion 13k. Accordingly, when the toner pack 10 is inserted into the supplying portion 200, the claw releasing portion 230f retracts the claw portion 13k toward the inside of the shutter member 11. By this, engagement between the claw portion 13k and the locking groove 11k is avoided, so that the shutter member 11 and the supply base 13 becomes rotatable relative to each other.

By the above, the rotation of the supply unit 101 around the rotational axis z is restricted, and also the shutter unit 102 is rotatable integrally with the mounting portion 210 and the receiving portion shutter 230. That is, when the toner pack 10 is mounted to the supplying portion 200, the toner receiving portion 220, the supply base 13, the expansion member 15, and the pouch 16 become a state in which these members are fixed to each other (state in which these members are not moved relative to each other). In this state, when the mounting portion 210 is rotated, the shutter unit 102 and the receiving portion shutter 230 are rotated around the rotational axis z relative to the toner receiving portion 220, the supply base 13, the expansion member 15, and the pouch 16.

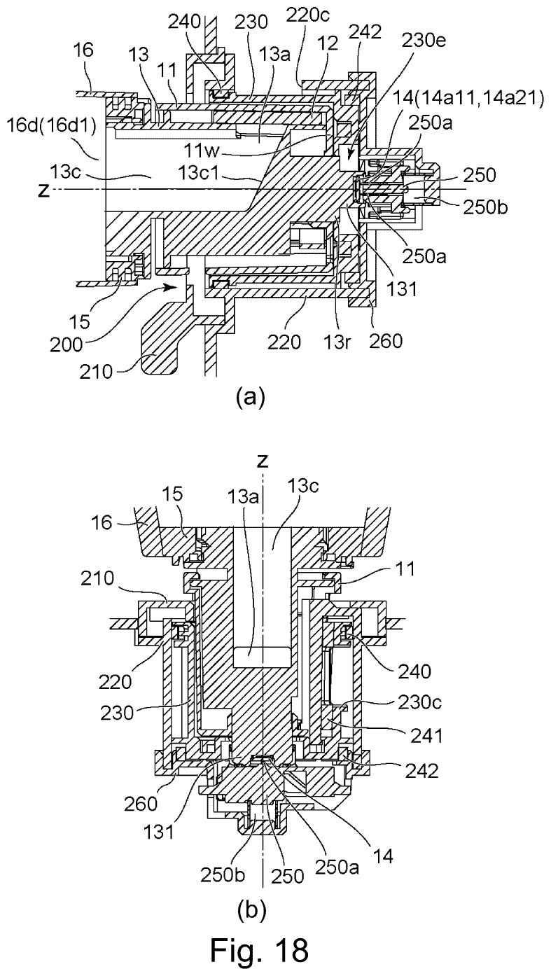

FIG. 18 includes illustrations of the supplying portion 200 to which the toner pack 10 is mounted. Part (a) of FIG. 18 is a sectional view passing through the rotational axis z and a center of the discharge opening 13a. Part (b) of FIG. 18 is a sectional view passing through the rotational axis z and perpendicular to part (a) of FIG. 18.

As shown in part (a) of FIG. 18, by engagement between the shaft portion 13r of the supply base 13 and the connecting hole 230e of the receiving portion shutter 230, the rotational axis z of the shutter unit 102 and the rotational axis z of the receiving portion shutter 230 coincide with each other. That is, the connecting hole 230e is a positioning portion for determining the position of the toner pack 10 relative to the image forming apparatus 1 with respect to the direction perpendicular to the direction of the rotational axis z. The shaft portion 13r is a portion-to-be-positioned which is positioned by the connecting hole 230e. In this embodiment, in a state in which the supply base 13 is fixed to the image forming apparatus 1, the shutter unit 102 moves around the supply base 13.

In this embodiment, the installation surface 131a is disposed at the tip portion of the shaft portion 13r. In other words, the electroconductive portion 14a of the memory tag 14 is disposed at the tip portion of the shaft portion 13r.

The supply base 13 is provided with the toner path 13c connected at one end thereof to the discharge opening 13a. In this embodiment, the other end of the toner path 13c is connected to the accommodating portion 16d (first accommodating portion 16d1) of the toner pack 16. Inside the toner path 13c, the toner supplied from the accommodating portion 16d (first accommodating portion 16d1) of the toner pack 16 passes toward the discharge opening 13a. The toner path 13c has a toner guiding surface (guiding surface) 13cl inclined relative to the direction of the rotational axis z and opposing the discharge opening 13a. The toner supplied from the toner pack 16 to the toner path 13c is easy to move toward the discharge opening 13a by the toner guiding surface 13c1. With respect to the rotational axis z, a position of the toner guiding surface 13cl overlaps with the position of the discharge opening 13a.

As viewed along the first direction, the electroconductive portion 14a (first electrode 14a1, second electrode 14a2) overlaps with the toner path 13c and the toner guiding surface 13c1. More specifically, the first exposed surface 14a11 and the second exposed surface 14a21 overlap with the toner path 13c and the toner guiding surface 13c1. That is, the electroconductive portion 14a can be disposed in a space-saving manner while ensuring sizes of the toner path 13c and the toner guiding surface 13c1.

Further, in this embodiment, with respect to the first direction, a position of the toner path 13c and a position of the electroconductive portion 14a do not overlap with each other. That is, with respect to the first direction, the toner path 13c and the electroconductive portion 14a are disposed in different positions (deviated positions). Accordingly, with respect to the direction perpendicular to the first direction, it is possible to suppress upsizing of the supply base 13 while ensuring an arrangement space of the toner path 13c and an arrangement space of the electroconductive portion 14a.

In this embodiment, the discharge opening 13a is disposed inside the shutter unit 102, and the first exposed surface 14a11 and the second exposed surface 14a21 are disposed outside the shutter unit 102. Accordingly, it is possible to suppress deposition of the toner on the first exposed surface 14a11 and the second exposed surface 14a21.

Further, the crossing wall 11w of the shutter member 11 is positioned between the discharge opening 13a and the first exposed surface 14a11 with respect to the direction of the rotational axis z (first direction). The crossing wall 11w of the shutter member 11 is positioned between the discharge opening 13a and the second exposed surface 14a21 with respect to the direction of the rotational axis z. In this embodiment, the crossing wall 11w is positioned between the electroconductive portion 14a of the memory tag 14 including the first exposed surface 14a11 and the second exposed surface 14a21, and the discharge opening 13a.

Further, in part (a) of FIG. 18, the shutter unit 102 is in the first position, and the seal member 12 covers the discharge opening 13a. At this time, the crossing wall 11w partitions between the electroconductive portion 14a of the memory tag 14 including the first exposed surface 14a11 and the second exposed surface 14a21, and the discharge opening 13a.

Accordingly, it is possible to suppress deposition of the toner on the electroconductive portion 14a of the memory tag 14 including the first exposed surface 14a11 and the second exposed surface 14a21.

Further, as shown in part (a) of FIG. 18 and part (b) of FIG. 18, the memory tag 14 fixed to the top portion of the toner pack 10 contacts the connector 250. The connector 250 engages with the above-described projected wall 131c. By this, with respect to the direction crossing (preferably perpendicular to) the first direction, the connector 250 is positioned relative to the toner pack 10.

Further, with mounting of the toner pack 10, the electroconductive portion 14a presses the connector electrode 250a into the direction along the rotational axis z. By this, the connector electrode 250a contacts the electroconductive portion 14a at a predetermined pressure so that the storing element of the memory tag 14 and the controller 399 of the image forming apparatus 1 are electrically connected to each other. More specifically, one connector electrode 250a contacts the first exposed surface 14a11, and the other connector electrode 250a contacts the second exposed surface 14a21.

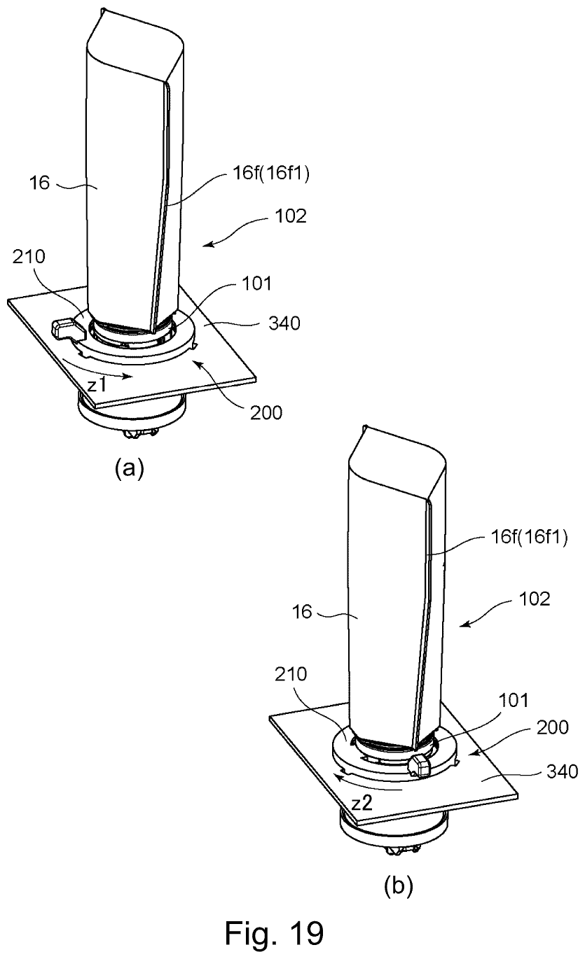

FIG. 19 includes illustrations of the supply portion 200 to which the toner pack 10 is mounted. Part (a) of FIG. 19 is the illustration before the mounting portion 210 is rotated. Part (b) of FIG. 19 is the illustration after the mounting portion 210 is rotated.

Discharge of the toner from the toner pack 10 toward the image forming apparatus 1 will be described. In order to perform the toner discharge, the user rotates the mounting portion 210 by about 90 degrees from a state in which the toner pack 10 is mounted to the supply portion 200 as shown in part (a) of FIG. 19, in z1 direction relative to the rotational axis z as shown in part (b) of FIG. 19.

As regards the toner pack 10, a length of the toner pack 10 with respect to the vertical direction in an attitude of the toner pack 10 mounted to the supply portion 200 (attitude during the use, attitude during the supply) is longer than a length of the toner pack 10 with respect to the horizontal direction. As described above, when the toner pack 10 is mounted to the supply portion 200, the mounting portion 210, the shutter unit 102, and the receiving portion shutter 230 are in an integrally rotatable state. Accordingly, by rotation of the mounting portion 210, the shutter unit 102 and the receiving portion shutter 230 are rotated integrally with the mounting portion 210. At this time, the pouch 16, the expansion member 15, and the supply base 13 are not moved (rotated) relative to the image forming apparatus 1. Further, when the shutter unit 102 and the receiving portion shutter 230 are rotated with the mounting portion 210, the toner receiving portion 220 is not moved (rotated).

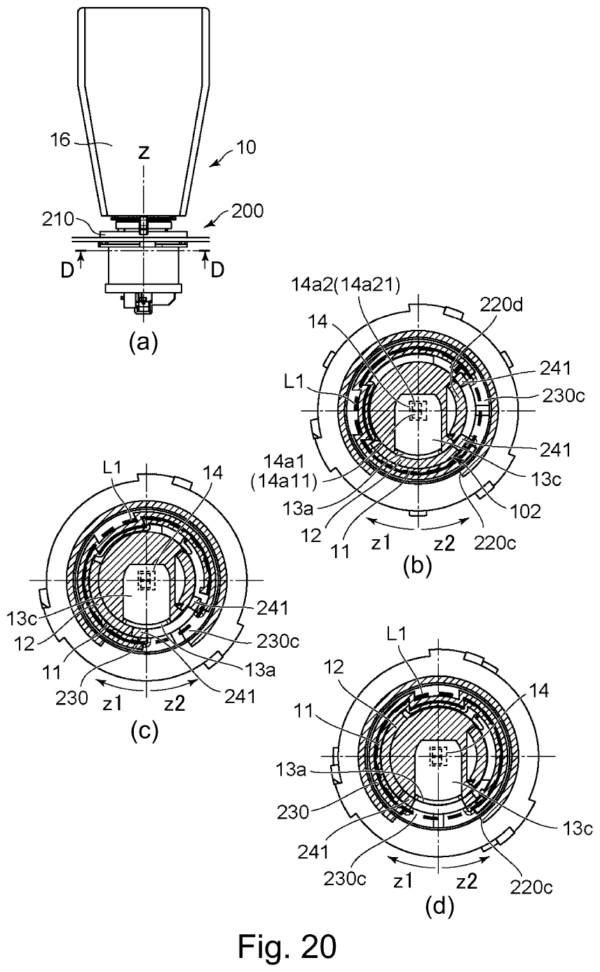

Here, in FIG. 20, a state in which the toner discharge is enabled by rotating the shutter unit 102 and the receiving portion shutter 230 is shown stepwise.

FIG. 20 includes illustrations of operations of the shutter unit 102 and the receiving portion shutter 230. Part (a) of FIG. 20 is the illustration in which the toner pack 10 mounted to the supply portion 200 is viewed from a side opposite from the discharge opening 13a along the direction perpendicular to the first direction. Parts (b) to (d) of FIG. 20 are sectional views in which a cut surface of the toner pack 10 and the supply portion 200 along a chain line D-D shown in part (a) of FIG. 20 is viewed from the tip (end) side of the toner pack 10. Further, in parts (b) to (d) of FIG. 20, an outer configuration of the memory tag 14 and the electroconductive portion 14a is projected by a broken line.

Part (b) of FIG. 20 is a state immediately after the toner pack 10 is mounted to the supply portion 200, and at this time, the discharge opening 13a is closed by the seal member 12 compressed by the shutter member 11. Further, the shutter opening 230c of the receiving portion shutter 230 is closed by the seal inner wall 220d and the receiving seal 241. When the user rotates the mounting portion 210, as shown in part (c) of FIG. 20, the shutter member 11, the seal member 12, the receiving portion shutter 230, and the receiving seal 241 are also integrally rotated. When the user further rotates the mounting portion 210, as shown in part (d) of FIG. 20, the discharge opening 13a of the toner pack 10, the shutter opening 230c of the receiving portion shutter 230, the shutter opening 230c of the receiving portion shutter 230, and the receiving opening 220c of the toner receiving portion 220 are in a communication state. Accordingly, the toner accommodated inside the pouch 16 can be discharged from the receiving opening to the accommodating portion 418 positioned inside the image forming apparatus 1.

As described above, as shown by thick broken lines in parts (b) to (d) of FIG. 20, it becomes possible to dispose the memory tag 14 within a range of the imaginary circle L1 of the shutter member 11.

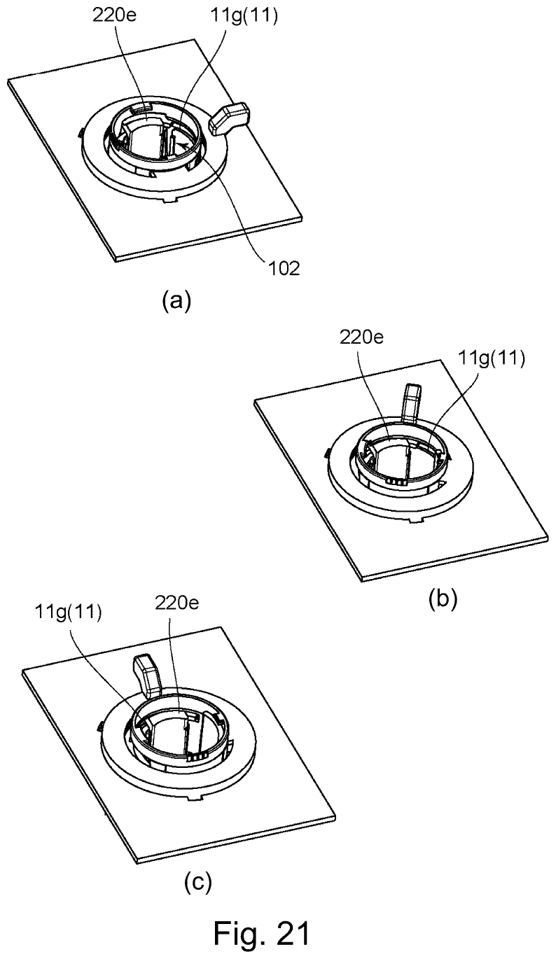

Next, retention of the toner pack 10 relative to the toner pack 10 with the rotation of the shutter unit 102 will be described using FIG. 21.

FIG. 21 includes illustrations regarding a constitution for restricting before the shutter unit 102 is rotated. Part (b) of FIG. 21 is the illustration during the rotation of the shutter unit 102. Part (c) of FIG. 21 is the illustration after the shutter unit 102 is rotated.

FIG. 21 includes the illustration showing the toner pack 10 in a state in which the toner pack 10 is mounted to the supply portion 200. In FIG. 21, a part of the components is omitted.

When the shutter unit 102 is rotated from a state of part (a) of FIG. 21 immediately after the toner pack 10 is mounted to the supply portion 200, the base supporting portion 220 of the toner receiving portion 220 enters the circumferential groove portion 11g of the shutter member 11. Here, as shown in part (c) of FIG. 13, the locking claws 11c and 11d engage with the flange portion 13s of the supply base 13, and therefore, the movement of the toner pack 10 in the first direction is restricted. More specifically, upward movement of the toner pack 10 in the first direction is restricted. Accordingly, there is no demounting of the toner pack 10 from the supply portion 200. Further, at the same time, there is no release of contact between the electroconductive portion 14a of the memory tag 14 and the connector electrode 250a of the connector 250.

Further, in this embodiment, a constitution is employed in which the toner pack 10 is mounted to the supply portion 200 so that the pouch 16 is positioned on an upper side of the vertical direction and the discharge opening 13a is positioned on a lower side of the vertical direction. By this, gravity can be utilized for discharging the toner. Further, the pouch 16 is formed in a flexible bag shape, and therefore the toner remaining in the pouch is a small amount by decreasing a volume inside the pouch 16 through a squeeze of the pouch 16 by the user, so that the toner can be discharged efficiently.

When the discharge of the toner is ended, an operating lever is rotated from the state of part (d) of FIG. 20 in the z2 direction by about 90 degrees, so that the discharge opening 13a is sealed by the shutter unit 101.

In the toner pack 10 in this embodiment, the discharge opening 13a formed at the side surface of the toner pack 10. In other words, the discharge opening 13a is formed at the surface (outer peripheral surface 13f) facing the direction crossing the first direction. On the other hand, the electroconductive portion 14a (first electrode 14a1, second electrode 14a2) was disposed on the end surface (surface facing the first direction, surface facing the downstream side with respect to the mounting direction of the toner pack 10) of the toner pack 10. More specifically, the first exposed surface 14a11 and the second exposed surface 14a21 are disposed on the end surface of the toner pack 10.

By the above-described arrangement of the discharge opening 13a and the electroconductive portion 14a, compared with the case where both the discharge opening 13a and the electroconductive portion 14a are disposed on the end surface of the toner pack 10, the discharge opening 13a and the electroconductive portion 14a can be disposed in the space-saving manner. By the above-described arrangement of the discharge opening 13a and the electroconductive portion 14a, compared with the case where the electroconductive portion 14a is disposed on the side surface of the toner pack 10 and the discharge opening 13a is disposed on the end surface, the discharge opening 13a or the toner path 13, and the electroconductive portion 14a can be disposed in the space-saving manner.

In other words, when a space in which the discharge opening 13a and the electroconductive portion 14a are disposed is ensured, a necessary space can be downsized. Or, a degree of freedom of arrangement of the discharge opening 13a and the electroconductive portion 14a can be improved.

Further, when the toner pack 10 is mounted to the image forming apparatus 1, the user supports the supply base 13 (or the shutter unit 102 at a periphery thereof), so that the user can stably mount the toner pack 10 to the image forming apparatus 1. At this time, the electroconductive portion 14a is disposed on the end surface of the supply base 13, and therefore, it is possible to suppress the user from touching the electroconductive portion 14a of the memory tag 14.

The electroconductive portion 14a of the memory tag 14 is disposed on the supply base 13 in a position with respect to crossing (preferably the direction perpendicular to) the first direction and the rotational direction around the rotational axis z. Accordingly, positional deviation between the electroconductive portion 14a and the connector electrode 250a of the image forming apparatus 1.

### Embodiment 2

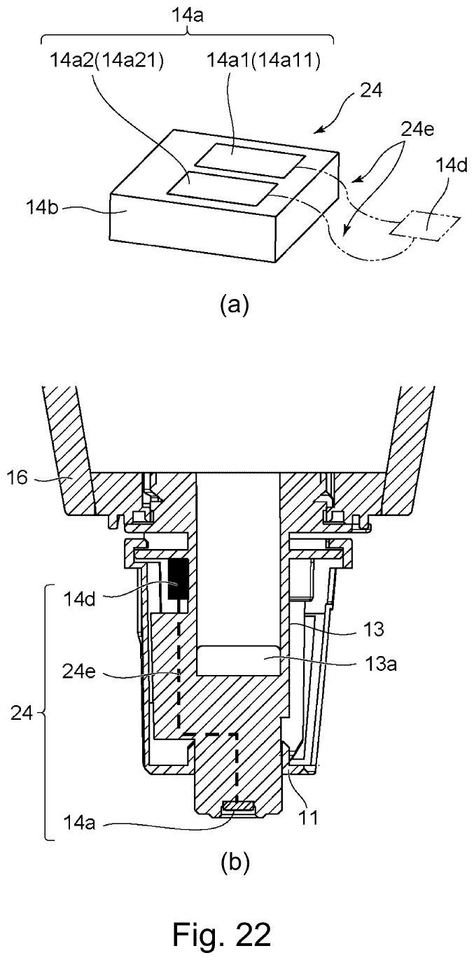

Next, a second embodiment of the present invention will be described using part (a) of FIG. 22 and part (b) of FIG. 22.

Portions similar to those in the embodiment 1 are represented by the same reference numerals or symbols and will be omitted from detailed description.

In this embodiment, a point such that a memory portion is different in constitution from the memory tag 14 as the memory unit and is constituted as a memory member 24 divided into a plurality of portions is different from the embodiment 1.

FIG. 22 includes views for illustrating the memory member according to this embodiment. Part (a) of FIG. 22 is the view for illustrating the memory member 24 according to this embodiment. Part (b) of FIG. 22 is the view for illustrating arrangement of the memory member 24.

The memory tag 14 shown in the embodiment 1 was held as a unit of the memory 14d and the electroconductive portion 14a on a single substrate. However, the memory member 24 in this embodiment is disposed in a position where the memory 14d is spaced from the holding portion 14b holding the electroconductive portion 14a as shown in part (a) of FIG. 22 and part (b) of FIG. 22. The electroconductive portion 14a (first electrode 14a1, second electrode 14a2) and the memory 14d are electrically connected to each other by an electroconductive path (signal line) 14e.

The memory 14d in this embodiment is disposed in a space between the supply base 13 and the shutter member 11. On the other hand, the holding portion 14b holding the electroconductive portion 14a is fixed to the supply base 13 of the toner pack 10 similarly as the memory tag 14 in the embodiment 1.

As described above, in the first embodiment, a memory unit constitution in which the memory portion is provided integrally with the electrode portion 14a and the supporting element 14d was employed, but in this embodiment, the memory portion 24 which is a separate member is used, so that the memory 14d can be disposed in a position spaced from the electroconductive portion 14a. Accordingly, a degree of arrangement freedom of the memory 14d is enhanced, so that it becomes possible to use the memory 14d with a large size.

### Modified Embodiment

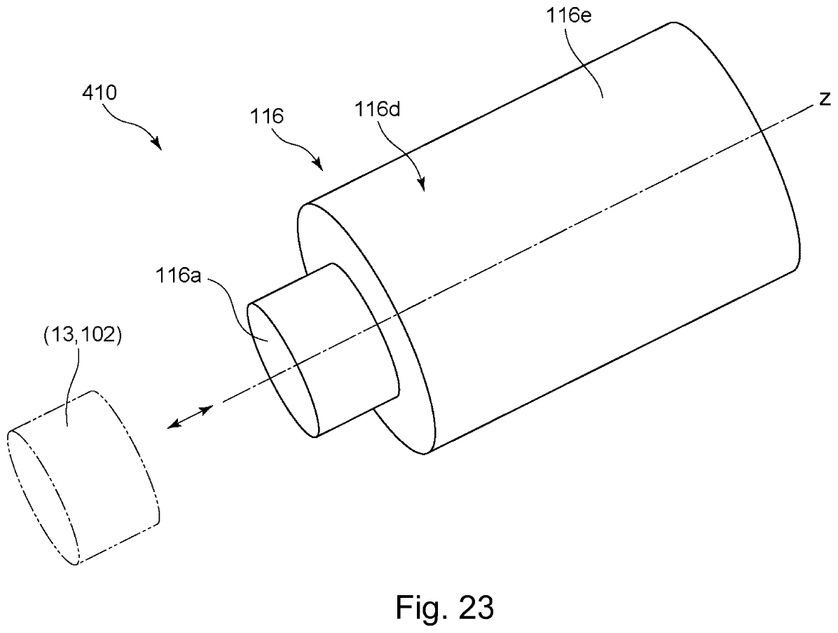

FIG. 23 is an illustration of a container portion accommodating toner according to a modified embodiment. A shape of the container portion (container) accommodating the toner is not limited to the bag shape such as the pouch 16. For example, as the container portion for accommodating the toner, it is also possible to use a bottle 116 in which a toner accommodating portion is formed.

A toner supply container 410 in this embodiment is provided with the bottle 116, and the supply base 13 and the shutter unit 102 which are shown in the embodiment 1.

The bottle 116 is provided with a wall 116e forming an accommodating portion 116d accommodating the toner. In the bottle 116, an opening 116a for permitting discharge of the toner from the accommodating portion 116d is formed. The bottle 116 can be used similarly as the pouch 16 by mounting the supply base 13 shown in the embodiment 1 to the opening 116a. Incidentally, the supply base 13 may also be mounted to the bottle 116 via a member such as the expansion member 15.

In this case, the bottle 116 may preferably have flexibility. Further, rigidity of the bottle 116 may preferably be lower than rigidity of the supply base 13. In this embodiment, the toner supply container 410 exhibits an attitude which is the same as the attitude when the toner supply container 410 is mounted to the image forming apparatus 1 and is used, and the bottle 116 is deformed in a state in which the toner is discharged from the discharge opening 13a, so that the toner can be discharged. In this case, the bottle 116 may preferably be constituted so that the accommodating portion 116d is compressed by 10% or more when a force of 100N or less acts in the direction perpendicular to the rotational axis z at least at a part of the accommodating portion 116d. More preferably, the bottle 116 may preferably be deformable so that the accommodating portion 116d is compressed by 25% or more (more preferably 50% or more) when a force of 40N or less (more preferably 20N or less) acts in the direction perpendicular to the rotational axis z at least at a part of the accommodating portion 116d.

The wall 116e of the bottle 116 according to this embodiment may preferably be made of a resin. Further, a thickness of the wall 116e may preferably be 1 mm or less, more preferably be 500 μm or less. In this embodiment, a thickness of a wall 14e is 100 to 300 μm. As a material of the mall 116e, for example, polyethylene terephthalate is preferable.

### Other Modified Embodiments

In the above-described embodiments, the developing roller 412 develops the electrostatic latent image in contact with the photosensitive drum 411. However, it is also possible to employ a constitution in which the developing roller 412 develops the electrostatic latent image in a state in which a gap is formed between the developing roller 412 and the photosensitive drum 411.

In the above-described embodiments, the toner remaining on the photosensitive drum 411 is removed (cleaning) by the cleaning unit 413. However, it is also possible to employ a constitution in which the toner remaining on the photosensitive drum 411 is collected in the accommodating portion 418 via the developing roller 412.

In the above-described embodiments, as the developer, the non-magnetic one-component developer can be used. However, a developer other than the non-magnetic one-component developer can also be used. For example, a magnetic one-component developer or a two-component developer can also be used.

Further, the container portion such as the pouch 16 or the bottle 116, and the supply base 13 may also be integrally formed.

### INDUSTRIAL APPLICABILITY

According to the present invention, there is provided a toner supply container and a mounting unit capable of being mounted to a container portion for accommodating toner.

The present invention is not restricted to the foregoing embodiments, but can be variously changed and modified without departing from the spirit and the scope of the present invention. Accordingly, the following claims are attached hereto to make public scope of the present invention.

This application claims the Conventional Priority based on Japanese Patent Application 2020-187416 filed Nov. 10, 2020, all disclosure of which is incorporated by reference herein.

1. A toner supply container comprising:
a container for accommodating toner;
a discharging portion provided on one end side of the container with respect to a first direction and including (i) a projection extending in the first direction and (ii) a discharge opening which opens toward a direction crossing the first direction and which is for permitting discharge of the toner; and
a shutter configured to be rotated around a first axis extending in the first direction and so as to move between a closed position where the shutter covers the discharge opening and a retracted position where the shutter is retracted from the closed position,
wherein the shutter includes a through hole, and
wherein the projection is inserted into the through hole.

2.-14. (canceled)

15. The toner supply container according to claim 1, wherein the shutter includes a crossing wall extending in a direction that crosses the first direction, the crossing wall including the through hole.

16. The toner supply container according to claim 15, wherein, with respect to the first direction, the crossing wall is disposed between a tip end of the projection and the discharge opening.

17. The toner supply container according to claim 16, further comprising a surface facing the first direction,
wherein the surface crosses the first axis.

18. The toner supply container according to claim 17, wherein, with respect to the first direction, the surface is closer to the discharge opening than the tip end of the projection is to the discharge opening.

19. The toner supply container according to claim 18, wherein the discharging portion includes a toner path that is connected to the discharge opening and through which the toner passes, and
wherein, as viewed in the first direction, the surface and the toner path overlap with each other.

20. The toner supply container according to claim 19, wherein the toner path includes a guide surface which is inclined relative to the first direction and which opposes the discharge opening, and
wherein, as viewed in the first direction, the surface and the guide surface overlap with each other.

21. The toner supply container according to claim 1, wherein the container is flexible and rigidity of the container is lower than rigidity of the discharging portion.

22. The toner supply container according to claim 1, wherein the toner supply container is detachably attachable to an image forming apparatus that includes a connecting portion, and
wherein the projection is contactable to the connecting portion.

23. The toner supply container according to claim 22, wherein the shutter is configured to move between the closed position and the retracted position in a state where the projection contacts to the connecting portion.

24. A mounting unit mountable to a container for accommodating toner, the mounting unit comprising:
a discharging portion provided on one end side of the container with respect to a first direction and including (i) a projection extending in the first direction and (ii) a discharge opening which opens toward a direction that crosses the first direction and which is for permitting discharge of the toner; and
a shutter configured to be rotated around a first axis extending in the first direction and so as to move between a closed position where the shutter covers the discharge opening and a retracted position where the shutter is retracted from the closed position,
wherein the shutter includes a through hole, and
wherein the projection is inserted into the through hole.

25. The mounting unit according to claim 24, wherein the shutter includes a crossing wall extending in a direction that crosses the first direction, the crossing wall including the through hole.

26. The mounting unit according to claim 25, wherein, with respect to the first direction, the crossing wall is disposed between a tip end of the projection and the discharge opening.

27. The mounting unit according to claim 26, further comprising a surface facing the first direction,
wherein the surface crosses the first axis.

28. The mounting unit according to claim 27, wherein, with respect to the first direction, the surface is closer to the discharge opening than the tip end of the projection is to the discharge opening.

29. The mounting unit according to claim 28, wherein the discharging portion includes a toner path that is connected to the discharge opening and through which the toner passes, and
wherein, as viewed in the first direction, the surface and the toner path overlap with each other.

30. The mounting unit according to claim 29, wherein the toner path includes a guide surface which is inclined relative to the first direction and which opposes the discharge opening, and
wherein, as viewed in the first direction, the surface and the guide surface overlap with each other.

31. The mounting unit according to claim 24, wherein the mounting unit is detachably attachable to an image forming apparatus that includes a connecting portion, and
wherein the projection is contactable to the connecting portion.

32. The mounting unit according to claim 31, wherein the shutter is configured to move between the closed position and the retracted position in a state where the projection contacts to the connecting portion.
